(19) United States
(12) Patent Application Publication
(10) Pub. No.: US 2010/0176351 A1
(43) Pub. Date: Jul. 15, 2010

(54) MIXTURES COMPRISING GRAPHITE AND GRAPHENE MATERIALS AND PRODUCTS AND USES THEREOF

(76) Inventors: Rodney S. Ruoff, Austin, TX (US); Sungjin Park, Austin, TX (US)

Correspondence Address: Ballard Spahr LLP, SUITE 1000, 999 PEACHTREE STREET, ATLANTA, GA, 30309-3915, US

(21) Appl. No.: 12/688,188

(22) Filed: Jan. 15, 2010

Related U.S. Application Data
(60) Provisional application No. 61/144,898, filed on Jan. 15, 2009.

(51) Int. Cl. H01B 1/24

(52) U.S. Cl. 252/510

(57) ABSTRACT

Disclosed are compositions comprising suspensions of graphite and/or graphene materials in a liquid, for example, comprising water, a first organic solvent, and optionally a second organic solvent. Also disclosed are methods of making and using the compositions.

### CROSS REFERENCE TO RELATED APPLICATIONS

This application claims priority to U.S. Provisional Patent Application Ser. No. 61/144,898, filed Jan. 15, 2009, which is hereby incorporated by reference.

### BACKGROUND

1. Technical Field

The present disclosure relates to mixtures comprising graphite oxide and graphene oxide and products and uses thereof.

2. Technical Background

Graphite materials and graphene materials are useful for a number of applications, due to their important properties, including mechanical strength, electrical conductivity, among others. Small sheets of graphite and graphene materials are of particular interest, which can be as thin as a single atom. These materials have a variety of excellent properties that make them desirable for use in semiconducting applications among a variety of other applications.

Unfortunately, sheets of graphite and graphene materials are hard to produce, in part due to the fact that the sheets are typically hydrophobic and often agglomerate in processing media, such as a solvent. Many solvents that do not have the right range of cohesive energies that allow for the adequate dispersion of graphite or graphene sheets. Moreover, the starting materials, such as graphite oxide or graphene oxide, typically used to make sheets of graphene or graphite material are also particularly troublesome and often difficult to process. Consequently, production of stable suspensions of graphite materials, graphene materials, and sheets thereof, is a significant challenge.

Thus, there is a need to address the aforementioned problems and other shortcomings associated with the production and processing of graphite and graphene materials. These needs and other needs are satisfied by the compositions and methods of the present disclosure.

### SUMMARY

In accordance with the purpose(s) of the invention, as embodied and broadly described herein, this disclosure, in one aspect, relates to mixtures comprising graphite material and graphene material and products and uses thereof.

In one aspect, disclosed are compositions comprising: a suspension of at least one of a graphite material or a graphene material in a mixture having a total volume and comprising a first organic solvent and optionally greater than about 0.1% by volume water, relative to the total volume.

In a further aspect, disclosed are compositions comprising: a suspension of at least one of a graphite material or a graphene material in a liquid having a total volume and comprising a first organic solvent, a second organic solvent, and optionally greater than about 0.1% by volume water, relative to the total volume.

Also disclosed are methods for modifying a graphite material or graphene material, the method comprising: (a) providing a suspension of at least one of a graphite material or graphene material in a liquid having a total volume and comprising a first organic solvent and greater than about 0.1% by volume water, relative to the total volume; and (b) reacting the at least one of a graphite material or graphene material, thereby providing a different graphite material or graphene material. Also disclosed are the products of the methods.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 is an exemplary schematic diagram for producing homogeneous colloidal suspensions of highly reduced graphene sheets.

FIG. 2 shows microscopic images of highly reduced graphene sheets. (a) an AFM image with 10 μm scale, (b) an AFM image with 2 μm scale and two corresponding height profiles, (c) a TEM image, scale bar=100 nm, (d) SEM images of the cross-section of the air-dried highly reduced graphene paper, and (e) the highly reduced graphene paper that had been “dried” at 150° C. under Ar(g).

FIG. 3 shows x-ray diffraction (XRD) plots of highly reduced graphene paper samples: TOP, dried at 150° C. under Argon(g) after air drying; MIDDLE, air-dried. BOTTOM, XRD of ‘graphene oxide paper’ sample, air-dried.

FIG. 4 shows XPS spectra of graphene oxide paper and highly reduced graphene paper samples: (a) survey spectra: TOP, air-dried graphene oxide; MIDDLE, air-dried highly reduced graphene; BOTTOM, highly reduced graphene dried at 150° C. under Ar(g) after air-drying, (b) C1s region of: TOP, de-convoluted spectrum of graphene oxide; MIDDLE, air-dried highly reduced graphene; BOTTOM: dried at 150° C. under Ar(g) after air-drying, (c) N1s region of: TOP, air-dried highly reduced graphene; BOTTOM, dried at 150° C. under Ar(g) after air-drying.

FIG. 5 shows FT-IR spectra of samples of air-dried graphene oxide paper (TOP) and air-dried highly reduced graphene paper (BOTTOM).

FIG. 6 shows Raman spectra of graphene oxide paper and highly reduced graphene paper samples: TOP, air-dried graphene oxide; MIDDLE, air-dried highly reduced graphene; BOTTOM, highly reduced graphene dried at 150° C. under Ar(g) after air drying.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

### A. DEFINITIONS

As used in the specification and the appended claims, the singular forms “a,” “an” and “the” include plural referents unless the context clearly dictates otherwise. Thus, for example, reference to “a graphene sheet,” “an electrode,” or “an electrolyte” includes mixtures of two or more graphene sheets, electrodes, or electrolytes, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

As used herein, the term “suspension” refers to a mixture comprising a liquid and a material suspended therein. Generally, the material suspended in the liquid is not dissolved nor substantially aggregated, but rather dispersed in the liquid. A material can be suspended in a liquid. However, it is not necessary that any portion of the suspended material be partially or wholly dissolved in the liquid. In one aspect, a suspension can comprise only one or more suspended materials disposed in one liquid or a mixture of liquids. In another aspect, a suspension can comprise a solution, wherein all or a portion of a suspended material is dissolved in the liquid or mixture of liquids. In yet another aspect, a suspension can comprise one or more suspended materials disposed in one or more liquids, wherein a portion of the suspended material is also dissolved in the one or more liquids. When a suspension is disclosed herein as being “substantially homogenous,” this is meant to refer to a mixture comprising a liquid having a material dispersed substantially throughout the liquid. To determine whether or not a suspension is “substantially homogenous,” a suspension can be, for example, visually inspected. If a suspension comprises deposits or obvious aggregates, the suspension is not “substantially homogenous.” Other methods include, for example, X-ray diffraction, sedimentation analysis, among others. If a solution or suspension comprises one or more aggregates that can be easily re-dispersed by, for example, sonication, such a solution can be substantially homogeneous, and the present disclosure is not intended to exclude such solutions or suspensions by the mere presence of an easily dispersible aggregate.

As used herein, the term “graphite material” refers to any material that comprises graphite. The term “graphite” refers to any form of graphite, including without limitation natural and synthetic forms of graphite, including, for example, crystalline graphites, expanded graphites, exfoliated graphites, and graphite flakes, sheets, powders, fibers, pure graphite, and graphite. When graphite is present, one or more graphitic carbons can have the characteristics of a carbon in an ordered three-dimensional graphite crystalline structure comprising layers of hexagonally arranged carbon atoms stacked parallel to each other. The presence of a graphitic carbon can be determined by X-ray diffraction. As defined by the International Committee for Characterization and Terminology of Carbon (ICCTC, 1982), and published in the Journal Carbon, Vol. 20, p. 445, a graphitic carbon can be any carbon present in an allotropic form of graphite, whether or not the graphite has structural defects.

As used herein, the term “graphene material” refers to any material that comprises graphene. The term “graphene” refers to any form of graphene, including without limitation natural and synthetic forms of graphene, including, for example, intercalated and non-intercalated graphene, chemically-functionalized graphene, stabilized graphene, and graphene. Any of the aforementioned graphene materials can be present in the form of a ribbon, sheet, a multilayer of sheets, a single atomically thick sheet, among other forms. The presence of graphene can be determined by microscopic methods, including without limitation AFM, TEM, SEM, and the like, and for example, by spectroscopic methods such as Raman.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly discussed above, the present disclosure relates generally to mixtures comprising graphite material or graphene material and products and uses thereof. Specifically disclosed are compositions comprising a suspension of at least one of a graphite material or a graphene material in a liquid having a total volume and comprising a first organic solvent and optionally greater than about 0.1% by volume water, relative to the total volume. In one aspect, the suspension can be a dispersion. In other aspects, the suspension can be a substantially homogenous dispersion, which is defined above. In still other aspects, the suspension can be a substantially non-homogenous dispersion.

### B. COMPOSITIONS

In one aspect, the suspension comprises a graphite material, a graphene material, or a combination thereof. As discussed above, the graphite material or graphene material can be any material that comprises any form of a graphite or graphene. In one aspect, the suspension can be used as a starting material suspension for the processing of the graphite material or graphene material. Examples of graphite and graphene starting materials include without limitation graphite oxide and graphene oxide. Thus, in one aspect, the graphite material or graphene material can be graphite oxide, graphene oxide, or a combination thereof.

Colloidal suspensions of conducting graphene sheets decorated/coated by surfactants/stabilizers (e.g, polymers, nanoparticles, small molecules, and polar solvents) have been produced. Thus, in one aspect, the suspensions can optionally comprise one or more stabilizers. Stabilizers can be used to aid in the dispersion or reduce aggregation of a graphite or graphene material in a liquid medium. An example of a stabilizer is poly(m-phenylenevinylene-co-2,5-dioctoxy-p-phenylenevinylene) (PmPV). Other examples of stabilizers include surfactants. As will be apparent, in one aspect, a surfactant is not necessary. Thus, in one aspect, a surfactant is not present. Examples of surfactants include without limitation 1,2-distearoyl-sn-glycero-3-phosphoethanolamine-N [methoxy(polyethyleneglycol)-5000] (DSPE-mPEG). In one aspect, 1,2-distearoyl-sn-glycero-3-phosphoethanolamine-N [methoxy(polyethyleneglycol)-5000] (DSPE-mPEG) is not present. In one aspect, a suspension can comprise a stabilizer. In another aspect, a suspension can comprise a surfactant. In yet another aspect, a suspension does not comprise a stabilizer, such as, for example, a surfactant. Stabilizers and surfactants are commercially available and a suitable stabilizer and/or surfactant, if desired, can be selected by one of skill in the art.

In a further aspect, the suspension comprises a graphite or graphene material that has been modified from a starting graphite or graphene material. In one aspect, modified graphite and graphene materials include without limitation at least one of chemically-functionalized graphene, reduced graphene, graphene, or a combination thereof. An example of reduced graphene is highly reduced graphene. In one aspect, the graphene material can be highly reduced graphene. “Highly reduced graphene” refers to graphene oxide that has been substantially reduced, or, for example, reduced to a level that imparts a desired conductivity to the reduced graphene. Thus, in one aspect, the graphene material can be electrically conductive. It is known in the art that oxygen containing functional groups, when present on graphene, can interfere with electrical conductivity. It should be noted that it is not necessary that a reduced or highly reduced graphene material comprise only hydrogen and carbon elements. In one aspect, a reduced or highly reduced graphene is fully hydrogenated. In another aspect, one or more sites of a reduced or highly reduced graphene material can comprise another element, such as for example, a nitrogen or oxygen.

In a still further aspect, the graphene material can be chemically-functionalized graphene, including chemically-modified graphene (CMG), which includes one-atom thick sheets of carbon optionally functionalized with other elements. If a particular surface of a chemically modified graphene material, or a portion thereof, is functionalized, such functionalization can, in various aspects, comprise multiple functional groups and can be uniform or can vary across any portion of the surface. In addition, functionalization can be to any extent suitable for use in a particular device. In one aspect, the degree of functionalization can be about up to the level wherein the conductivity of the CMG material is no longer suitable for use in a desired application or device. Graphite and graphene materials, such as those recited herein, are commercially available and/or can be produced by one of skill in the art in possession of this disclosure.

The graphite or graphene material can be intercalated or non-intercalated. In one aspect, at least a portion of the graphite or graphene material is intercalated. In another aspect, at least a portion of the graphite or graphene material is non-intercalated. An intercalator can comprise a substance that can diffuse between two or more sheets of graphite or graphene material. Intercalators are commonly used to exfoliate, or break apart, multiple sheets of graphite or graphene. It will be appreciated that, in various aspects, the present compositions can adequately disperse a graphite or graphene material without the aid of an intercalator. In one aspect, the graphite or graphene material is not intercalated. Exemplary intercalators can comprise oleum (fuming sulphuric acid with 20% free SO₃) and tetrabutylammonium hydroxide (TBA). Thus, in one aspect, the graphite or graphene material is not intercalated with oleum. Intercalators and intercalation compounds are commercially available and are known to those of skill in the art.

As discussed above, the graphite material and/or graphene material can be present in liquids comprising a first solvent and optionally greater than about 0.1% by volume water, relative to the total volume. In one aspect, water is present in the suspension to first provide a predispersion of the graphite and/or graphene material before the first solvent is added to the composition to form a mixture with the water. In another aspect, water and other other solvents, such as a first organic solvent, can be added in any order. Water can be present in any amount above about 0.1% by volume, relative to the total volume of the mixture. The mixture can have, for example, from about 0.1 to about 5% by volume water, for example, about 0.1, 0.2, 0.3, 0.4, 0.5, 0.8, 1.0, 1.2, 1.4, 1.6, 1.8, 2, 2.2, 2.5, 2.8, 3.0, 3.3, 3.6, 3.9, 4.2, 4.6, 4.8, or 5% by volume water; from about 0.1 to about 3% by volume water, for example, about 0.1, 0.2, 0.3, 0.4, 0.5, 0.6, 0.7, 0.8, 0.9, 1, 1.1, 1.3, 1.5, 1.7, 1.9, 2.1, 2.3, 2.5, 2.7, 2.9, or 3% by volume water; from about 0.1 to about 2% by volume water, for example, about 0.1, 0.2, 0.3, 0.6, 0.9, 1.1, 1.2, 1.4, 1.6, 1.8, or 2% by volume water; or from about 0.1 to about 1% by volume water, for example, about 0.1, 0.2, 0.3, 0.4, 0.5, 0.6, 0.7, 0.8, 0.9, or 1% by volume water. In further aspects, the mixture can have, for example, from about 0.2 to about 5% by volume water, from about 0.2 to about 3% by volume water, from about 0.2 to about 2% by volume water, or from about 0.2 to about 1% by volume water. In one aspect, the mixture can have about 1% by volume water. In still other aspects, the mixture can have greater than about 5% by volume water, and the present invention is not intended to be limited to any particular water concentration. The water used need not always be pure water, and aqueous mixtures can also be used. For example, an aqueous salt mixture can be used. In other aspects, all or a portion of the water present in a mixture, once formed, can be removed, providing a mixture comprising no or substantially no water, such as for example, less than about 2, 1, 0.5, 0.1, 0.001, 0.0001% by volume water. In one aspect, at least a portion of the water present can be located between two or more layers of the graphite and/or graphene material. In another aspect, the amount of water present does not include any water that may be located between two or more layers of the graphite and/or graphene material.

The first organic solvent can be any organic solvent which is at least partially miscible with water, when water is present in the mixture of greater than about 0.1% by volume, relative to the total volume, or any of the aforementioned volume percentages. As used herein, an “organic solvent” refers to a solvent that comprises at least one carbon atom.

In one aspect, the first organic solvent can be selected based on its Hansen solubility parameters. Hansen solubility parameters are discussed in Hansen, C. M. Hansen Solubility Parameters: A User's Handbook (CRC Press, Hoboken, 2007), and include the δ_{d} (dispersion cohesion parameter), the δₚ (polarity cohesion parameter), and the δₕ (hydrogen bonding cohesion parameter). In various aspects, the present invention is directed use of solubility parameters to select an appropriate liquid system and is not limited to any particular mathematical relationship between any two or more such parameters. At least one relationship between solubility parameters is disclosed herein and the present invention is intended to include any other such mathematical relationships as can be deemed appropriate through routine experimentation.

In one aspect, the first organic solvent can be selected based on a relationship between a combination of two or more of the Hansen solubility parameters. In a further aspect, the first organic solvent can be selected based on the sum of δₚ and δₕ (i.e., δₚ+δₕ). Suitable first organic solvents include those without limitation having a (δₚ+δₕ) of at least about 10, at least about 13, at least about 15, at least about 20, or at least about 25. In a further aspect, the first organic solvent can be an organic solvent having a (δₚ+δₕ) of not greater than 59, not greater than 55, not greater than 50, not greater than 40, or not greater than 30. Thus, in one aspect, the first organic solvent can comprise a (δₚ+δₕ) of from about 10 to about 30, from about 13 to about 30, from about 13 to about 29, from about 20 to about 60, from about 20 to about 50, or from about 20 to about 30. In one aspect, the first organic solvent has a (δₚ+δₕ) of from about 20 to about 60. In a further aspect, the first organic solvent has a (δₚ+δₕ) of from about 10 to about 30. In a still further aspect, the first organic solvent has a (δₚ+δₕ) of from about 13 to about 29.

In one aspect, the first organic solvent can be one or more solvents disclosed in Table 1, including combinations thereof.

TABLE 1
Examples of the first/second organic solvent comprising (δₚ + δₕ) ≧ 10
and (δₚ + δₕ) ≦ 30.

| Solvent | δₚ | δₕ | δₚ + δₕ |
|---|---|---|---|
| N-butyl acetate | 3.7 | 6.3 | 10 |
| chlorine | 10 | 0 | 10 |
| o-difluorobenzene | 9 | 1 | 10 |
| methyl-1-propenyl ether | 4.3 | 5.7 | 10 |
| methyl chloride | 6.1 | 3.9 | 10 |
| 1,1,2,2-tetrachloropropane | 6.7 | 3.3 | 10 |
| vinyl ether | 4.2 | 5.8 | 10 |
| dioctyl phthalate | 7 | 3.1 | 10.1 |
| ethylene glycol butyl methyl ether | 5.2 | 4.9 | 10.1 |
| isoamyl acetate | 3.1 | 7 | 10.1 |
| allyl methyl ether | 4.3 | 5.9 | 10.2 |
| bromoform | 4.1 | 6.1 | 10.2 |
| divinyl sulfide | 4.6 | 5.6 | 10.2 |
| methyl butyl ketone | 6.1 | 4.1 | 10.2 |
| methyl isobutyl ketone | 6.1 | 4.1 | 10.2 |
| thiophene | 2.4 | 7.8 | 10.2 |
| butyl isopropenyl ether | 5.3 | 5 | 10.3 |
| methyl-p-toluate | 6.5 | 3.8 | 10.3 |
| 1,1-difluoroethylene | 6.8 | 3.6 | 10.4 |
| isopropyl chloride (2-chloro propane) | 8.3 | 2.1 | 10.4 |
| methylal | 1.8 | 8.6 | 10.4 |
| 1,1,2,2-tetrachloroethane | 5.1 | 5.3 | 10.4 |
| vinyl butyl sulfide | 5 | 5.4 | 10.4 |
| 4-bromo-1-butane | 6 | 4.5 | 10.5 |
| o-bromostyrene | 5.2 | 5.3 | 10.5 |
| 1,3-butadiene-1-chloro | 8.5 | 2 | 10.5 |
| 1-butenyl-methyl ether (cis) | 5.3 | 5.2 | 10.5 |
| 1,3-dichloro-2-butene | 7.8 | 2.7 | 10.5 |
| ethyl vinyl ether | 4.9 | 5.6 | 10.5 |
| di-isoheptyl phthalate | 7.2 | 3.4 | 10.6 |
| dipropyl ketone | 5.7 | 4.9 | 10.6 |
| ethylene glycol diethyl ether | 5.4 | 5.2 | 10.6 |
| 4-fluoropropylphenone | 7.1 | 3.5 | 10.6 |
| isobutyleneoxide | 4.8 | 5.8 | 10.6 |
| 2-methyl-1,3-dioxolane | 4.8 | 5.8 | 10.6 |
| oleyl alcohol | 2.6 | 8 | 10.6 |
| phosgene | 5.3 | 5.3 | 10.6 |
| tributylphosphate | 6.3 | 4.3 | 10.6 |
| 1-chloro-4-ethoxybenzene | 6.3 | 4.4 | 10.7 |
| o-chlorofluorobenzene | 8.7 | 2 | 10.7 |
| 1,1-diethoxy ethanol (acetal) | 5.4 | 5.3 | 10.7 |
| 1,3-dimethoxy butane | 5.5 | 5.2 | 10.7 |
| ethyl bromide | 8.4 | 2.3 | 10.7 |
| 1,1,1-trifluoroethane | 10.7 | 0 | 10.7 |
| anisole | 4.1 | 6.7 | 10.8 |
| 1,1-dichloroethane | 7.8 | 3 | 10.8 |
| 2,3-dichloropropene | 7.8 | 3 | 10.8 |
| vinyl butyrate | 3.9 | 6.9 | 10.8 |
| 2-bromo-propene | 6 | 4.9 | 10.9 |
| 5-bromo-2-nitrobenzotrifluoride | 6 | 4.9 | 10.9 |
| p-bromotoluene | 6.8 | 4.1 | 10.9 |
| 1-chloro-1-fluoro-ethylene | 6.9 | 4 | 10.9 |
| 4-fluoro-3-nitrobenzofluoride | 7.2 | 3.7 | 10.9 |
| methyl vinyl sulfide | 4.9 | 6 | 10.9 |
| carbon dioxide | 6.9 | 4.1 | 11 |
| dibenzyl ether | 3.7 | 7.3 | 11 |
| dimethyl acetylene | 3.4 | 7.6 | 11 |
| isopropyl amine (2-propan amine) | 4.4 | 6.6 | 11 |
| 3-methyl-cyclohexanone | 6.3 | 4.7 | 11 |
| 2-methyl-cyclohexanone | 6.3 | 4.7 | 11 |
| bromoprene | 6.4 | 4.7 | 11.1 |
| N-butyl acrylate | 6.2 | 4.9 | 11.1 |
| 2-chloroethyl ethyl sulfide | 5 | 6.1 | 11.1 |
| methyl ethyl ether | 4.9 | 6.2 | 11.1 |
| 4-bromo-1,2-butadiene | 6.5 | 4.7 | 11.2 |
| diallyl amine | 4.5 | 6.7 | 11.2 |
| 1,2-dichloroethylene (cis) | 8 | 3.2 | 11.2 |
| dihexyl phthalate | 7.6 | 3.6 | 11.2 |
| dihydropyran | 5.5 | 5.7 | 11.2 |
| isobutyl acrylate | 6.2 | 5 | 11.2 |
| 2-thiabutane | 5.9 | 5.3 | 11.2 |
| 2,3,4-trifluoro-nitrobenzene | 7.7 | 3.5 | 11.2 |
| sec-butyl acetate | 3.7 | 7.6 | 11.3 |
| 1-chloro-2-methylpropene | 7.1 | 4.2 | 11.3 |
| 2,4-dichloro-5-nitrobenzotrifluoride | 7.6 | 3.7 | 11.3 |
| 3,4-dichloronitrobenzene | 7.2 | 4.1 | 11.3 |
| 1,1-dichloropropane | 7.8 | 3.5 | 11.3 |
| oxalyl chloride | 3.8 | 7.5 | 11.3 |
| 1-bromo-propene (cis) | 6.4 | 5 | 11.4 |
| cyclohexanone | 6.3 | 5.1 | 11.4 |
| 2,4-dichloro-3-fluoronitrobenzene | 7.2 | 4.2 | 11.4 |
| 1,2-dichloropropene (cis) | 8.5 | 2.9 | 11.4 |
| methyl bromide | 8.8 | 2.6 | 11.4 |
| bis (chloromethyl) ether | 4.9 | 6.6 | 11.5 |
| diethylene glycol diethyl ether | 5.9 | 5.6 | 11.5 |
| ethylene dichloride | 7.4 | 4.1 | 11.5 |
| octanoic acid | 3.3 | 8.2 | 11.5 |
| 1-propanethiol | 5.8 | 5.7 | 11.5 |
| triethyleneglycol monooleyl ether | 3.1 | 8.4 | 11.5 |
| p-chloro-acetophenone | 7.6 | 4 | 11.6 |
| methyl vinyl ether | 5.3 | 6.3 | 11.6 |
| N-benzyl-pyrrolidone | 6.1 | 5.6 | 11.7 |
| hexyleneglycol diacetate | 4.5 | 7.2 | 11.7 |
| vinyl bromide | 6.3 | 5.4 | 11.7 |
| 3-bromopropyne | 6.5 | 5.3 | 11.8 |
| p-chlorobenzoyl chloride | 6.7 | 5.1 | 11.8 |
| cyanogen | 11.8 | 0 | 11.8 |
| 1,1-dibromo-ethylene | 4.8 | 7 | 11.8 |
| o-dibromobenzene | 6.5 | 5.3 | 11.8 |
| 1,3-dichloro-2-fluorobenzene | 9.1 | 2.7 | 11.8 |
| dimethyl ether | 6.1 | 5.7 | 11.8 |
| ethyl-1-propynyl ether | 6.4 | 5.4 | 11.8 |
| vinyl allyl ether | 6.5 | 5.3 | 11.8 |
| butadione | 5.1 | 6.8 | 11.9 |
| 3-chlorobenzyl chloride | 9.3 | 2.6 | 11.9 |
| methoxyhexanone (pentoxone) | 6 | 5.9 | 11.9 |
| methyl methacrylate | 6.5 | 5.4 | 11.9 |
| N-propyl acetate | 4.3 | 7.6 | 11.9 |
| vinyl trifluoroacetate | 4.3 | 7.6 | 11.9 |
| p-bromobenzoyl-chloride | 6.5 | 5.5 | 12 |
| chloro-difluoromethane (Freon-22) | 6.3 | 5.7 | 12 |
| dimethyl cellosolve | 6 | 6 | 12 |
| 2-bromobutane | 7.7 | 4.4 | 12.1 |
| butyleneoxide | 6.2 | 5.9 | 12.1 |
| 4-chlorobenzonitrile | 8 | 4.1 | 12.1 |
| cyclodecanone | 8 | 4.1 | 12.1 |
| ethoxyethyl propionate | 3.3 | 8.8 | 12.1 |
| ethylene dibromide | 3.5 | 8.6 | 12.1 |
| iodobenzene | 6 | 6.1 | 12.1 |
| thionyl chloride | 6.2 | 5.9 | 12.1 |
| 1,1,2-trichloroethane | 5.3 | 6.8 | 12.1 |
| tridecyl alcohol | 3.1 | 9 | 12.1 |
| vinyl ethyl sulfide | 5.8 | 6.3 | 12.1 |
| allyl bromide (3-bromoprene) | 7.3 | 4.9 | 12.2 |
| 1-chloro-vinyl ethyl ether | 6.5 | 5.7 | 12.2 |
| dimethyl ketene | 7.4 | 4.8 | 12.2 |
| mesityl oxide | 6.1 | 6.1 | 12.2 |
| methyl-1-propynyl ether | 6.3 | 5.9 | 12.2 |
| acetophenone | 8.6 | 3.7 | 12.3 |
| benzonitrile | 9 | 3.3 | 12.3 |
| o-bromochlorobenzene | 7.7 | 4.6 | 12.3 |
| butyraldehyde | 5.3 | 7 | 12.3 |
| 3,4-dichlorotoluene | 9.8 | 2.5 | 12.3 |
| diethyl ketone | 7.6 | 4.7 | 12.3 |
| diethylene glycol butyl ether acetate | 4.1 | 8.2 | 12.3 |
| ethyl cinnamate | 8.2 | 4.1 | 12.3 |
| ethylene glycol di-t-butyl-ether | 4.1 | 8.2 | 12.3 |
| methyl-n-propyl-ketone | 7.6 | 4.7 | 12.3 |
| tetrahydropyran | 6.3 | 6 | 12.3 |
| diethyl disulfide | 6.7 | 5.7 | 12.4 |
| methylene dichloride | 6.3 | 6.1 | 12.4 |
| allyl acetate | 4.5 | 8 | 12.5 |
| N-butyl amine | 4.5 | 8 | 12.5 |
| 1-chloro-2-ethoxybenzene | 8.1 | 4.4 | 12.5 |
| 2-chloroethyl ethyl ether | 7.9 | 4.6 | 12.5 |
| ethyl acetate | 5.3 | 7.2 | 12.5 |
| 4-iodo-1,2-butadiene | 6.3 | 6.2 | 12.5 |
| vinyl 2-chloro-ethyl ether | 6.7 | 5.8 | 12.5 |
| 1-decanol | 2.6 | 10 | 12.6 |
| di-(2-methoxyethyl) ether | 6.1 | 6.5 | 12.6 |
| ethyl acrylate | 7.1 | 5.5 | 12.6 |
| 1-acetoxy-1,3-butadiene | 4.4 | 8.3 | 12.7 |
| benzaldehyde | 7.4 | 5.3 | 12.7 |
| benzoyl chloride | 8.2 | 4.5 | 12.7 |
| dibutyl phthalate | 8.6 | 4.1 | 12.7 |
| dimethyl amine dimer | 4.8 | 7.9 | 12.7 |
| isopropyl acetate | 4.5 | 8.2 | 12.7 |
| methyl ethyl ketoxime | 4.9 | 7.8 | 12.7 |
| nitrobenzene | 8.6 | 4.1 | 12.7 |
| vinylpropionate | 8 | 4.7 | 12.7 |
| 4-chlorobenzaldehyde | 7.2 | 5.6 | 12.8 |
| pine oil | 3 | 9.8 | 12.8 |
| vinyliodide(iodoethene) | 5.5 | 7.3 | 12.8 |
| 2-butyl octanol | 3.6 | 9.3 | 12.9 |
| 2,4-dichloronitrobenzene | 8.7 | 4.2 | 12.9 |
| dipropylene glycol monomethyl ether acetate | 4.9 | 8 | 12.9 |
| methyl benzoate | 8.2 | 4.7 | 12.9 |
| propyl-methacrylate | 6.3 | 6.6 | 12.9 |
| anethole (trans) | 4.3 | 8.7 | 13 |
| 1-bromo-4-ethoxy-benzene | 7.7 | 5.3 | 13 |
| N-butyl-methacrylate | 6.4 | 6.6 | 13 |
| 1,1-dichloroacetone | 7.6 | 5.4 | 13 |
| hexachloroacetone-2 (g.c.) | 6.6 | 6.4 | 13 |
| methacrylic acid | 2.8 | 10.2 | 13 |
| methyl acetylene | 3.8 | 9.2 | 13 |
| methyl iodide | 7.7 | 5.3 | 13 |
| N-acetyl morpholine | 5.3 | 7.8 | 13.1 |
| N-butyl aceto acetate | 5.8 | 7.3 | 13.1 |
| ketene | 7.3 | 5.8 | 13.1 |
| 2,4-pentanedione | 9 | 4.1 | 13.1 |
| gamma thiobutyrolactone | 6.9 | 6.2 | 13.1 |
| vinyl acetate | 7.2 | 5.9 | 13.1 |
| 1,1-difluoroethane | 10.2 | 3 | 13.2 |
| 1,4-butandiol diacrylate | 9.1 | 4.2 | 13.3 |
| di-(2-chloro-isopropyl) ether | 8.2 | 5.1 | 13.3 |
| ethylene glycol butyl ether acetate | 4.5 | 8.8 | 13.3 |
| ethyleneglycol methyl-t-butyl-ether | 5.1 | 8.2 | 13.3 |
| nonyl phenol | 4.1 | 9.2 | 13.3 |
| 2-propanethiol | 6.8 | 6.5 | 13.3 |
| propylene glycol-monoethyl-ether-acetate | 4.3 | 9 | 13.3 |
| skatole | 7.1 | 6.2 | 13.3 |
| 1,1,2,2-tetrabromoethane | 5.1 | 8.2 | 13.3 |
| tetrahydrothiophene | 7.5 | 5.8 | 13.3 |
| 6-chloro-2-nitrotoluene | 9.6 | 3.8 | 13.4 |
| dibromomethane | 6.4 | 7 | 13.4 |
| N-acetyl caprolactam | 8.7 | 4.8 | 13.5 |
| 1,3-butadiene-1,2-di-chloro | 10.7 | 2.8 | 13.5 |
| 2-ethyl croton aldehyde | 8 | 5.5 | 13.5 |
| p-nitro-toluene | 9.6 | 3.9 | 13.5 |
| pentafluorobenzophenone | 8.1 | 5.4 | 13.5 |
| propyl amine | 4.9 | 8.6 | 13.5 |
| sulfur dicyanide | 13.5 | 0 | 13.5 |
| trichloroacetonitrile | 7.4 | 6.1 | 13.5 |
| vinyl-2-methoxy-ethyl ether | 6.7 | 6.8 | 13.5 |
| dimethyl carbonate | 3.9 | 9.7 | 13.6 |
| ethanethiol (ethyl mercaptan) | 6.5 | 7.1 | 13.6 |
| 2,4,5-trichlorothiophenol | 4.5 | 9.1 | 13.6 |
| 1-methoxy-1,3-butadiene | 8.3 | 5.4 | 13.7 |
| propyleneglycol-monobutyl ether | 4.5 | 9.2 | 13.7 |
| tetrahydrofuran | 5.7 | 8 | 13.7 |
| vinylacetylene | 1.7 | 12 | 13.7 |
| p-chloronitrobenzene | 9.6 | 4.2 | 13.8 |
| dimethyl sulfide | 6.4 | 7.4 | 13.8 |
| ethyl ethynyl ether | 7.9 | 5.9 | 13.8 |
| methyl sulfide | 6.4 | 7.4 | 13.8 |
| 2-decanol | 3.9 | 10 | 13.9 |
| di-isobutyl carbinol | 3.1 | 10.8 | 13.9 |
| butyric anhydride | 6.3 | 7.7 | 14 |
| p-fluoroanisole | 7.3 | 6.7 | 14 |
| indole | 7.5 | 6.5 | 14 |
| tolylene diisocyanate | 7.9 | 6.1 | 14 |
| vinyl crotonate | 5 | 9 | 14 |
| 4-vinyl pyridine | 7.2 | 6.8 | 14 |
| allyl mercaptan | 6.2 | 7.9 | 14.1 |
| bromotrichloro-methane #2-gc | 8.1 | 6 | 14.1 |
| cyclooctanone | 9.6 | 4.5 | 14.1 |
| diethyl phthalate | 9.6 | 4.5 | 14.1 |
| methyl ethyl ketone | 9 | 5.1 | 14.1 |
| morpholine | 4.9 | 9.2 | 14.1 |
| pyrrole | 7.4 | 6.7 | 14.1 |
| 1,2,4,5-tetrachlorobenzene (g.c.) | 10.7 | 3.4 | 14.1 |
| thiacyclopropane | 9.1 | 5 | 14.1 |
| allylformate | 5.4 | 8.8 | 14.2 |
| butyrylchloride | 9.4 | 4.8 | 14.2 |
| 2,4-dichlorobenzaldehyde | 8.8 | 5.4 | 14.2 |
| epichlorohydrin | 7.6 | 6.6 | 14.2 |
| glycidyl methacrylate | 8.5 | 5.7 | 14.2 |
| methyl propionate | 6.5 | 7.7 | 14.2 |
| pentachlorocyclopropane | 10.5 | 3.7 | 14.2 |
| benzophenone | 8.6 | 5.7 | 14.3 |
| benzyl-butyl phthalate | 11.2 | 3.1 | 14.3 |
| carbonylcyanide | 6.3 | 8 | 14.3 |
| diethylene glycol-monoethyl-ether acetate | 5.1 | 9.2 | 14.3 |
| dimethyl disulfide | 7.8 | 6.5 | 14.3 |
| 2,3-dithiabutane | 7.8 | 6.5 | 14.3 |
| hexafluorohexanol | 4.4 | 9.9 | 14.3 |
| 1,4-thioxane | 6.6 | 7.7 | 14.3 |
| diethylene glycol methyl-t-butyl-ether | 7.2 | 7.2 | 14.4 |
| 2,6-difluorobenzonitrile | 11.2 | 3.2 | 14.4 |
| 3,5-difluorobenzonitrile | 11.2 | 3.2 | 14.4 |
| 2,5-dimethyl pyrrole | 7.6 | 6.8 | 14.4 |
| ethyleneglycol monoethyl ether acrylate | 5.1 | 9.3 | 14.4 |
| allylmercaptan | 5.2 | 9.3 | 14.5 |
| 4-chloroanisole | 7.8 | 6.7 | 14.5 |
| cyanogens chloride | 14.5 | 0 | 14.5 |
| di-p-tolylsulfoxide | 11.4 | 3.1 | 14.5 |
| ethyl isocyanate | 12 | 2.5 | 14.5 |
| ethylene glycol diacetate | 4.7 | 9.8 | 14.5 |
| ethylene glycol monoisobutyl ether | 4.9 | 9.6 | 14.5 |
| isovaleraldehyde | 9.5 | 5 | 14.5 |
| propylene glycol monoisobutyl ether | 4.7 | 9.8 | 14.5 |
| acetoxime | 3.7 | 10.9 | 14.6 |
| ethynyl methyl ether | 8.1 | 6.5 | 14.6 |
| ethynyl methyl ether | 8.1 | 6.5 | 14.6 |
| quinoline | 7 | 7.6 | 14.6 |
| butyric acid | 4.1 | 10.6 | 14.7 |
| 4-chloro-1,2-butadiene | 8 | 6.7 | 14.7 |
| chloro-acetylchloride | 9.2 | 5.5 | 14.7 |
| 2,2-dichlorodiethyl ether | 9 | 5.7 | 14.7 |
| 2,4-difluoronitrobenzene | 11 | 3.7 | 14.7 |
| ethyl methacrylate | 7.2 | 7.5 | 14.7 |
| pyridine | 8.8 | 5.9 | 14.7 |
| methyl acetate | 7.2 | 7.6 | 14.8 |
| thiophenol | 4.5 | 10.3 | 14.8 |
| 2,6-dichloroanisole | 8.4 | 6.5 | 14.9 |
| 2,6-dichloroanisole | 8.4 | 6.5 | 14.9 |
| 4-pentenal | 8.1 | 6.8 | 14.9 |
| acrolein | 7.2 | 7.8 | 15 |
| chloral | 7.4 | 7.6 | 15 |
| o-bromoanisole | 8.4 | 6.7 | 15.1 |
| p-bromobenzonitrile | 9.3 | 5.8 | 15.1 |
| chloroacetone | 9.6 | 5.5 | 15.1 |
| N,N-dibutyl-formamide | 8.9 | 6.2 | 15.1 |
| 3,4-epoxy-1-butene | 7.7 | 7.4 | 15.1 |
| ethyl-hypochlorite | 8.6 | 6.5 | 15.1 |
| ethyl iodide | 7.9 | 7.2 | 15.1 |
| 2-ethyl hexanol | 3.3 | 11.8 | 15.1 |
| cyanogens bromide | 15.2 | 0 | 15.2 |
| 3,4-dichlorophenyl acetonitrile | 10.8 | 4.4 | 15.2 |
| diethylene glycol divinyl ether | 7.3 | 7.9 | 15.2 |
| 1-octanol | 3.3 | 11.9 | 15.2 |
| pentamethylene sulfide | 6.3 | 8.9 | 15.2 |
| tetrahydrothiapyran | 6.3 | 8.9 | 15.2 |
| vinylpyrrolidone | 9.3 | 5.9 | 15.2 |
| aniline | 5.1 | 10.2 | 15.3 |
| N,N-dichloroethyl amine | 7.6 | 7.7 | 15.3 |
| dimethyl diethylene glycol | 6.1 | 9.2 | 15.3 |
| 1,2-epoxy-propene | 8.6 | 6.7 | 15.3 |
| ethylene glycol monoethyl-ether-acetate | 4.7 | 10.6 | 15.3 |
| propylene oxide | 8.6 | 6.7 | 15.3 |
| cycloheptanone | 10.6 | 4.8 | 15.4 |
| propylene glycol monomethyl-ether-acetate | 5.6 | 9.8 | 15.4 |
| trifluoromethane (Freon-23) | 8.9 | 6.5 | 15.4 |
| allyl acetoacetate | 6.9 | 8.6 | 15.5 |
| bromoacetylene | 9.9 | 5.6 | 15.5 |
| bromomethyl methyl ether | 8.5 | 7 | 15.5 |
| N,N-dichloromethyl amine | 7.5 | 8 | 15.5 |
| ethylene sulfide | 9 | 6.5 | 15.5 |
| 4-chloro-2-nitrotoluene | 11.8 | 3.8 | 15.6 |
| chloroacetonitrile | 13.6 | 2 | 15.6 |
| isophorone | 8.2 | 7.4 | 15.6 |
| methyl isobutyl carbinol | 3.3 | 12.3 | 15.6 |
| propionyl chloride | 10.3 | 5.3 | 15.6 |
| thioacetic acid | 6.7 | 8.9 | 15.6 |
| N-N-butyl-pyrrolidone | 9.9 | 5.8 | 15.7 |
| N-chlorodimethylamine | 7.8 | 7.9 | 15.7 |
| cyclopropylmethylketone | 11.1 | 4.6 | 15.7 |
| diethoxy disulfide | 8.3 | 7.4 | 15.7 |
| di-isopropyl methyl phosphonate | 10 | 5.7 | 15.7 |
| dimethyl phthalate | 10.8 | 4.9 | 15.7 |
| acetyl bromide | 10.6 | 5.2 | 15.8 |
| p-bromonitrobenzene | 9.9 | 5.9 | 15.8 |
| 1-chloro-methyl-acrylate | 7.3 | 8.5 | 15.8 |
| dichloroacetonitrile | 9.4 | 6.4 | 15.8 |
| ethyl-vinyl ketone | 11.3 | 4.5 | 15.8 |
| tetramethylene sulfide | 6.7 | 9.1 | 15.8 |
| valeronitrile | 11 | 4.8 | 15.8 |
| 1,3-dioxolane | 6.6 | 9.3 | 15.9 |
| 1,2-ethane dithiol | 7.2 | 8.7 | 15.9 |
| 2-octanol | 4.9 | 11 | 15.9 |
| 2,4,6-trichlorophenol | 5.1 | 10.8 | 15.9 |
| 2,2,4-trimethyl-1,3-pentanediol-monoisobutyrate | 6.1 | 9.8 | 15.9 |
| tripropylene glycol monomethyl-ether | 5.5 | 10.4 | 15.9 |
| allylacetic acid | 4.7 | 11.3 | 16 |
| diethylene glycol hexyl-ether | 6 | 10 | 16 |
| dimethyl amine | 4.8 | 11.2 | 16 |
| acetylene (ethyne) | 4.2 | 11.9 | 16.1 |
| 3-butoxybutanol | 5.5 | 10.6 | 16.1 |
| 2-chloroallylidene diacetate | 7.3 | 8.8 | 16.1 |
| di-isopropyl phosphonofluoridate | 10.2 | 5.9 | 16.1 |
| methyl acrylate | 6.7 | 9.4 | 16.1 |
| phenyl acetonitrile | 12.3 | 3.8 | 16.1 |
| allylacetonitrile (4-pentenenitrile) | 11.2 | 5 | 16.2 |
| 3-ethoxy-propionaldehyde | 8.8 | 7.4 | 16.2 |
| hydrogen sulfide | 6 | 10.2 | 16.2 |
| 2-nitropropane | 12.1 | 4.1 | 16.2 |
| propylene glycol monopropyl ether | 7 | 9.2 | 16.2 |
| vinylformate | 6.5 | 9.7 | 16.2 |
| allylamine | 5.7 | 10.6 | 16.3 |
| ethyl amine | 5.6 | 10.7 | 16.3 |
| methyl mercaptan | 7.7 | 8.6 | 16.3 |
| methyl allyl cyanide | 11.3 | 5.1 | 16.4 |
| N-acetyl piperidine | 10 | 6.5 | 16.5 |
| N-butyl salicylate | 4.8 | 11.7 | 16.5 |
| 1,2-dichlorovinyl ethyl ether | 10.5 | 6 | 16.5 |
| N,N,N,N-tetramethylthiourea | 6 | 10.5 | 16.5 |
| cyclobutanone | 11.4 | 5.2 | 16.6 |
| di-isobutyl sulfoxide | 10.5 | 6.1 | 16.6 |
| din-butyl sulfoxide | 10.5 | 6.1 | 16.6 |
| dichloroacetaldehyde | 9.1 | 7.5 | 16.6 |
| ethylidene acetone | 12.1 | 4.5 | 16.6 |
| isobutyl sulfoxide | 10.5 | 6.1 | 16.6 |
| methyl isopropenyl ketone | 12.1 | 4.5 | 16.6 |
| benzoic acid | 6.9 | 9.8 | 16.7 |
| butoxy-ethoxy propanol | 6.5 | 10.2 | 16.7 |
| butyl lactate | 6.5 | 10.2 | 16.7 |
| 4-ethoxy-acetophenone | 10.3 | 6.4 | 16.7 |
| ethyl chloroformate | 10 | 6.7 | 16.7 |
| propionaldehyde | 6.7 | 10 | 16.7 |
| ethyl formate | 8.4 | 8.4 | 16.8 |
| propylene glycol monophenyl-ether | 5.3 | 11.5 | 16.8 |
| tricresyl phosphate | 12.3 | 4.5 | 16.8 |
| butadiene-4-cyano | 11.7 | 5.2 | 16.9 |
| 1,1-dimethyl hydrazine | 5.9 | 11 | 16.9 |
| dipropylene glycol methyl-ether | 5.7 | 11.2 | 16.9 |
| ethylene glycol mono-t-butyl-ether | 6.1 | 10.8 | 16.9 |
| propylene glycol mono-t-butyl-ether | 6.1 | 10.8 | 16.9 |
| acetylchloride | 11.2 | 5.8 | 17 |
| acrylylchloride | 11.6 | 5.4 | 17 |
| o-chlorothiophenol | 7 | 10 | 17 |
| 2,3-dichloronitrobenzene | 12.6 | 4.4 | 17 |
| dihydrogen disulfide | 6.3 | 10.7 | 17 |
| dimethyl diketone | 5.3 | 11.7 | 17 |
| propylene glycol monoethyl-ether | 6.5 | 10.5 | 17 |
| trimethyleneoxide | 9.8 | 7.2 | 17 |
| borinecarbonyl | 10.2 | 6.9 | 17.1 |
| cyclopentanone | 11.9 | 5.2 | 17.1 |
| ethylene glycol monomethyl-ether-acetate | 5.5 | 11.6 | 17.1 |
| propylene glycol monoisopropyl-ether | 6.1 | 11 | 17.1 |
| 1,1-dibromoethane | 8.4 | 8.8 | 17.2 |
| hydrazine | 8.3 | 8.9 | 17.2 |
| trichloroacetic acid | 5.8 | 11.4 | 17.2 |
| trimethylenesulfide | 7.8 | 9.4 | 17.2 |
| di-(2-chloroethoxy)methane | 10.2 | 7.1 | 17.3 |
| acetone | 10.4 | 7 | 17.4 |
| acetylacetone | 11.2 | 6.2 | 17.4 |
| diazomethane | 6.1 | 11.3 | 17.4 |
| 1-ethoxy-ethoxy-2-propanol | 5.7 | 11.7 | 17.4 |
| ethylene glycol monobutyl-ether | 5.1 | 12.3 | 17.4 |
| tribromoethylene | 9.4 | 8 | 17.4 |
| butyronitrile | 12.4 | 5.1 | 17.5 |
| ethylene imine | 9.8 | 7.7 | 17.5 |
| methyl vinyl ketone | 12.5 | 5 | 17.5 |
| vinylacetic acid | 5.2 | 12.3 | 17.5 |
| cyclohexanol | 4.1 | 13.5 | 17.6 |
| diethyleneglycol monobutyl ether | 7 | 10.6 | 17.6 |
| 2-methyl (cis)-acrylic-acid | 5.2 | 12.4 | 17.6 |
| epsilon caprolactam | 13.8 | 3.9 | 17.7 |
| propionic acid | 5.3 | 12.4 | 17.7 |
| p-anisidine (methoxy aniline) | 6.5 | 11.3 | 17.8 |
| diphenyl sulfone | 14.4 | 3.4 | 17.8 |
| 2-(diethylamino)ethanol | 5.8 | 12 | 17.8 |
| 2,6-dimethyl-phenol | 4.9 | 12.9 | 17.8 |
| 2-ethyl-1-butanol | 4.3 | 13.5 | 17.8 |
| 1-nitropropane | 12.3 | 5.5 | 17.8 |
| 1,3,5-trioxane | 9.2 | 8.6 | 17.8 |
| 2-methyl-1-chloro-acrolein | 10.6 | 7.3 | 17.9 |
| propylene glycol monomethyl-ether | 6.3 | 11.6 | 17.9 |
| m-cresol | 5.1 | 12.9 | 18 |
| N,N-dimethyl-butyramide | 10.6 | 7.4 | 18 |
| N-formyl-hexamethylene-imine | 10.4 | 7.6 | 18 |
| methyl-chloroformate | 9.5 | 8.5 | 18 |
| 2-chlorocyclohexanone | 13 | 5.1 | 18.1 |
| ethylene glycol monobenzyl-ether | 5.9 | 12.2 | 18.1 |
| 1-chloro-1-nitroethane | 13.5 | 4.7 | 18.2 |
| 2,3-dibromoprene | 11.8 | 6.4 | 18.2 |
| 4-methoxy-acetophenone | 11.2 | 7 | 18.2 |
| allylisocyanide | 13 | 5.4 | 18.4 |
| 2-chloroethylacetate | 9.6 | 8.8 | 18.4 |
| 2,5-dichlorophenol | 6.3 | 12.1 | 18.4 |
| 2,6-dichlorophenol | 7.5 | 10.9 | 18.4 |
| N-formyl-piperidine | 10.6 | 7.8 | 18.4 |
| 1-pentanol | 4.5 | 13.9 | 18.4 |
| sulfur dioxide | 8.4 | 10 | 18.4 |
| diethylene glycol monopropyl-ether | 7.2 | 11.3 | 18.5 |
| isoamyl-alcohol(3-methyl-1-butanol) | 5.2 | 13.3 | 18.5 |
| methacryl aldehyde | 11.1 | 7.4 | 18.5 |
| methyl formate | 8.4 | 10.2 | 18.6 |
| nonyl-phenoxy ethanol | 10.2 | 8.4 | 18.6 |
| formyl fluoride | 10.1 | 8.6 | 18.7 |
| N,N-diethyl-acetamide | 11.3 | 7.5 | 18.8 |
| ethyl thiocyanate | 13.4 | 5.4 | 18.8 |
| methyl nitrate | 14 | 4.8 | 18.8 |
| di-isopropyl sulfoxide | 11.5 | 7.4 | 18.9 |
| ethylene-methyl sulfonate | 9.3 | 9.6 | 18.9 |
| 3,3,3-trichloropropene | 15.5 | 3.4 | 18.9 |
| chloronitromethane | 13.5 | 5.5 | 19 |
| diacetone alcohol | 8.2 | 10.8 | 19 |
| vinyl amine | 7.2 | 11.8 | 19 |
| 1,1,2-trichloropropene | 15.7 | 3.4 | 19.1 |
| 1,2,3-trichloropropene | 15.7 | 3.4 | 19.1 |
| 4-chlorothiophenol | 8.6 | 10.6 | 19.2 |
| hexafluoro isopropanol | 4.5 | 14.7 | 19.2 |
| tetramethylurea | 8.2 | 11 | 19.2 |
| acetaldehyde | 8 | 11.3 | 19.3 |
| ethyl-cyanoacrylate | 10.3 | 9 | 19.3 |
| 2-chlorophenol | 5.5 | 13.9 | 19.4 |
| dichloromethyl methyl ether | 12.9 | 6.5 | 19.4 |
| 3,4-dimethyl phenol | 6 | 13.4 | 19.4 |
| 2-methyl-1-butanol | 5.1 | 14.3 | 19.4 |
| 2-methyl-2-butanol | 6.1 | 13.3 | 19.4 |
| N-methyl-2-pyrrolidone | 12.3 | 7.2 | 19.5 |
| acrylonitrile | 12.8 | 6.8 | 19.6 |
| acetylfluoride | 14 | 5.7 | 19.7 |
| pentachlorophenol | 6.9 | 12.8 | 19.7 |
| 2-pentanol | 6.4 | 13.3 | 19.7 |
| tigaldehyde | 12.9 | 6.8 | 19.7 |
| allylisothiocyanate | 11.3 | 8.5 | 19.8 |
| t-butyl alcohol | 5.1 | 14.7 | 19.8 |
| propionitrile | 14.3 | 5.5 | 19.8 |
| thiocyanic acid | 8.9 | 10.9 | 19.8 |
| allylcyanide | 14.3 | 5.6 | 19.9 |
| 3-butenenitrile | 14.3 | 5.6 | 19.9 |
| 2,3-butylene carbonate | 16.8 | 3.1 | 19.9 |
| hexamethylphosphoramide | 8.6 | 11.3 | 19.9 |
| benzyl alcohol | 6.3 | 13.7 | 20 |
| furfural | 14.9 | 5.1 | 20 |
| nitroethane | 15.5 | 4.5 | 20 |
| 2-phenoxy-ethanol | 5.7 | 14.3 | 20 |
| ethyl lactate | 7.6 | 12.5 | 20.1 |
| fluoromethane | 10.6 | 9.5 | 20.1 |
| tetramethylene sulfoxide | 11 | 9.1 | 20.1 |
| triethylene glycol monomethyl-ether | 7.6 | 12.5 | 20.1 |
| 2-butanol | 5.7 | 14.5 | 20.2 |
| isooctyl-alcohol | 7.3 | 12.9 | 20.2 |
| succinaldehyde (butanedial) | 9.8 | 10.5 | 20.3 |
| 2,2,6,6-tetrachlorocyclohexanone | 14 | 6.3 | 20.3 |
| 3-chloro-1-propanol | 5.7 | 14.7 | 20.4 |
| di-n-propylsulfoxide | 13 | 7.4 | 20.4 |
| diethylene glycol monomethyl-ether | 7.8 | 12.6 | 20.4 |
| 4-chlorobenzyl alcohol | 7.5 | 13 | 20.5 |
| methacrylonitrile | 15.1 | 5.4 | 20.5 |
| butadienedioxide | 14.4 | 6.2 | 20.6 |
| N,N-diethyl-formamide | 11.4 | 9.2 | 20.6 |
| dimethyl-methyl phosphonate | 13.1 | 7.5 | 20.6 |
| propargylaldehyde | 11.9 | 8.7 | 20.6 |
| triethylphosphate | 11.4 | 9.2 | 20.6 |
| crotonic acid | 8.7 | 12 | 20.7 |
| phenol | 5.9 | 14.9 | 20.8 |
| 2-chloropropenal | 12.9 | 8.1 | 21 |
| ethyl carbylamine | 15.2 | 5.8 | 21 |
| ethylene glycol sulfite | 15.9 | 5.1 | 21 |
| ethylene oxide | 10 | 11 | 21 |
| methyl thiocyanate | 15 | 6 | 21 |
| 3-azidopropene | 7.7 | 13.4 | 21.1 |
| 1-fluoro acrylonitrile | 15.4 | 5.7 | 21.1 |
| acrylic acid | 6.4 | 14.9 | 21.3 |
| ethylene glycol monoisopropyl-ether | 8.2 | 13.1 | 21.3 |
| formyl fluoride | 13.4 | 7.9 | 21.3 |
| propionamide | 9.8 | 11.5 | 21.3 |
| N-acetyl-pyrrolidone | 13.1 | 8.3 | 21.4 |
| diethylene glycol monoethyl-ether | 9.2 | 12.2 | 21.4 |
| fumaronitrile | 13.6 | 7.8 | 21.4 |
| aceticacid | 8 | 13.5 | 21.5 |
| 2-acetyl-thiophene | 12.2 | 9.3 | 21.5 |
| 1-butanol | 5.7 | 15.8 | 21.5 |
| 3-chloropropionaldehyde | 13.3 | 8.2 | 21.5 |
| o-methoxyphenol (guaiacol) | 8.2 | 13.3 | 21.5 |
| 3-methyl-allyl alcohol | 6 | 15.5 | 21.5 |
| trifluoroacetic acid | 9.9 | 11.6 | 21.5 |
| isobutyl alcohol | 5.7 | 15.9 | 21.6 |
| 2-methyl-1-propanol | 5.7 | 15.9 | 21.6 |
| nitroethylene | 16.6 | 5 | 21.6 |
| N,N-dimethyl-acetamide | 11.5 | 10.2 | 21.7 |
| ethanesulfonylchloride | 14.9 | 6.8 | 21.7 |
| 1-fluoro-acrylic acid | 8.7 | 13 | 21.7 |
| azidoethane | 8.9 | 12.9 | 21.8 |
| 2-chloropropenoic acid | 9.4 | 12.4 | 21.8 |
| diethyl sulfate | 14.7 | 7.1 | 21.8 |
| aceticanhydride | 11.7 | 10.2 | 21.9 |
| cyclopropylnitrile | 16.2 | 5.7 | 21.9 |
| methyl salicylate | 8 | 13.9 | 21.9 |
| chloropropionitrile | 15.9 | 6.1 | 22 |
| 4-methoxy-benzonitrile | 16.7 | 5.4 | 22.1 |
| propylenecarbonate | 18 | 4.1 | 22.1 |
| 3-methoxypropionitrile | 14.4 | 7.8 | 22.2 |
| crotonaldehyde | 14.9 | 7.4 | 22.3 |
| caprolactone (epsilon) | 15 | 7.4 | 22.4 |
| methyl-phosphonic-difluoride | 14 | 8.4 | 22.4 |
| 2-propanol | 6.1 | 16.4 | 22.5 |
| methacrylamide | 11 | 11.6 | 22.6 |
| propionaldehyde-2,3-epoxy | 12.4 | 10.2 | 22.6 |
| chloro-acetic acid | 10.4 | 12.3 | 22.7 |
| furfuryl alcohol | 7.6 | 15.1 | 22.7 |
| methyl sulfolane | 17.4 | 5.3 | 22.7 |
| ethyl carbamate | 10.1 | 13 | 23.1 |
| 2-cyclopentenyl alcohol | 7.6 | 15.6 | 23.2 |
| diketene | 15.1 | 8.1 | 23.2 |
| propynonitrile | 17 | 6.3 | 23.3 |
| 2,3-butadiene-1-ol | 6.6 | 16.8 | 23.4 |
| ethylene glycol monoethyl-ether | 9.2 | 14.3 | 23.5 |
| methyl hydrazine | 8.7 | 14.8 | 23.5 |
| ethyl isothiocyanate | 14.7 | 9 | 23.7 |
| 2,3-dichloropropanol | 9.2 | 14.6 | 23.8 |
| 1,2,3-triazole | 8.8 | 15 | 23.8 |
| nitromethane | 18.8 | 5.1 | 23.9 |
| gamma butyrolactone | 16.6 | 7.4 | 24 |
| sulfolane | 16.6 | 7.4 | 24 |
| acetonitrile | 18 | 6.1 | 24.1 |
| isocyanic acid | 10.5 | 13.6 | 24.1 |
| succinonitrile | 16.2 | 7.9 | 24.1 |
| acetaldoxime | 4 | 20.2 | 24.2 |
| 2-butynedinitrile | 16.2 | 8 | 24.2 |
| 1-propanol | 6.8 | 17.4 | 24.2 |
| trans-crotononitrile | 18.8 | 5.5 | 24.3 |
| methyl vinyl sulfone | 19.6 | 4.8 | 24.4 |
| 1,3-dichloro-2-propanol | 9.9 | 14.6 | 24.5 |
| dimethyl ethanolamine | 9.2 | 15.3 | 24.5 |
| isoxazole | 13.4 | 11.2 | 24.6 |
| methyl amine | 7.3 | 17.3 | 24.6 |
| acrylamide | 12.1 | 12.8 | 24.9 |
| dimethyl formamide | 13.7 | 11.3 | 25 |
| chloro acetaldehyde | 16.1 | 9 | 25.1 |
| malononitrile | 18.4 | 6.7 | 25.1 |
| propylenechlorohydrin | 9.8 | 15.3 | 25.1 |
| salicylaldehyde | 10.7 | 14.7 | 25.4 |
| ethylene glycol monomethyl-ether | 9.2 | 16.4 | 25.6 |
| acetanilide | 13.3 | 12.4 | 25.7 |
| ethylenediamine | 8.8 | 17 | 25.8 |
| methyl glyoxal | 16.1 | 9.7 | 25.8 |
| ethylene chlorohydrin | 8.8 | 17.2 | 26 |
| 2-bromo-allyl alcohol | 9.9 | 16.2 | 26.1 |
| trimethyl phosphate | 15.9 | 10.2 | 26.1 |
| hexylene glycol | 8.4 | 17.8 | 26.2 |
| methyl isothiocyanate | 16.2 | 10.1 | 26.3 |
| 2-chloro-allyl alcohol | 10.2 | 16.4 | 26.6 |
| dimethyl sulfoxide | 16.4 | 10.2 | 26.6 |
| hydrogen cyanide | 17.6 | 9 | 26.6 |
| hydroxyethyl acrylate | 13.2 | 13.4 | 26.6 |
| 3-methyl isoxazole | 14.8 | 11.8 | 26.6 |
| 3-chloro-allyl alcohol | 10.3 | 16.5 | 26.8 |
| ethylene carbonate | 21.7 | 5.1 | 26.8 |
| 1-methyl-imidazole | 15.6 | 11.2 | 26.8 |
| pyruvonitrile | 18.9 | 8 | 26.9 |
| allyl alcohol | 10.8 | 16.8 | 27.6 |
| diethylenetriamine | 13.3 | 14.3 | 27.6 |
| acetonecyanhydrin | 12.2 | 15.5 | 27.7 |
| vinylenecarbonate | 18.1 | 9.6 | 27.7 |
| ethanol | 8.8 | 19.4 | 28.2 |
| dipropylene glycol | 10.6 | 17.7 | 28.3 |
| formic acid | 11.9 | 16.6 | 28.5 |
| propiolactone | 18.2 | 10.3 | 28.5 |
| 2-pyrolidone | 17.4 | 11.3 | 28.7 |
| pyridazine | 17.4 | 11.7 | 29.1 |
| tetramethylene sulfone | 18.2 | 10.9 | 29.1 |
| 1,3-benzenediol | 8.4 | 21 | 29.4 |
| crotonlactone | 19.8 | 9.6 | 29.4 |
| thiazole | 18.8 | 10.8 | 29.6 |
| formaldehyde | 14.4 | 15.4 | 29.8 |

In a further aspect, the first solvent can be one or more of acetone, acetonitrile, tetrahydrofuran (THF), dimethyl formamide (DMF), N-methyl pyrollidone (NMP), dimethyl sulfoxide (DMSO), ethanol, pyridine, diethylether, toluene, methanol, or a combination thereof. It should be appreciated that, in one aspect, adding acetone or tetrahydrofuran to a dispersion of graphite oxide provided suspensions of graphene oxide sheets. However, particles visible to the eye (but not precipitated) were observed after 1 day. The resulting mixtures were readily re-dispersed by short sonication or stirring and then such particles, not precipitated, were again seen by eye after 1 day. In one aspect, precipitation of agglomerated graphene oxide sheets was immediately observed by the addition of diethylether or toluene to the aqueous suspension.

The ratio of water to the first organic solvent can be any suitable ratio. In one aspect, the ratio of the first organic solvent to water, if present, can be about 100:1, 50:1, 40:1, 30:1, 20:1, 15:1, 13:1, 10:1, or 9:1. In another aspect, the ratio of the first organic solvent to water is at least about 7:1 or at least about 9:1. In a specific aspect, the ratio of the first organic solvent to water can be about 9:1. For example, when the first organic solvent is DMF, the DMF/H₂O ratio can be about 9:1.

The second organic solvent, when present, can be any suitable organic solvent. The second organic solvent can be the same or different as the first organic solvent. In one aspect, the second organic solvent can be different than the first organic solvent. In a further aspect, the second organic solvent can be selected based on its Hansen solubility parameters, as discussed above. Thus, the second organic solvent can have any of the above disclosed solubility parameters, including the minimum, maximum, and solubility parameter ranges disclosed above.

In one aspect, the second organic solvent can be selected based on the sum of δₚ and δₕ (δₚ+δₕ). Suitable second organic solvents include those without limitation having a (δₚ+δₕ) of at least about 10, at least about 13, at least about 15, at least about 20, or at least about 25. In a further aspect, the second organic solvent can be an organic solvent having a (δₚ+δₕ) of not greater than 59, not greater than 55, not greater than 50, not greater than 40, or not greater than 30. Thus, in one aspect, the second organic solvent can comprise a (δₚ+δₕ) of from about 10 to about 30, from about 13 to about 30, from about 13 to about 29, from about 20 to about 60, from about 20 to about 50, or from about 20 to about 30. In one aspect, the second organic solvent has a (δₚ+δₕ) of from about 20 to about 60. In a further aspect, the second organic solvent has a (δₚ+δₕ) of from about 10 to about 30. In a still further aspect, the second organic solvent has a (δₚ+δₕ) of from about 13 to about 29. In one aspect, the second solvent is one or more solvents disclosed in Table 1, including combinations thereof.

The amount of the second solvent, when present, can be any desired amount. In one aspect, the second solvent can be present in an amount greater than the first solvent. In another aspect, the ratio of the second organic solvent to the first organic solvent can be about 100:1, 50:1, 40:1, 30:1, 20:1, 15:1, 13:1, 10:1, or 9:1. In another aspect, the ratio of the second organic solvent to the first organic solvent is at least about 7:1 or at least about 9:1. In one aspect, the ratio of the second solvent to the first solvent to the water can be about 90:9:1. In one aspect, the mixture can comprise the second organic solvent, DMF, and water, at a ratio of about 90:9:1. In one aspect, the second organic solvent can be at least one of DMF, DMSO, THF, NMP, acetonitrile, acetone, ethanol, diethylether, toluene, or DCB. For example, any of DMF, DMSO, THF, NMP, acetonitrile, acetone, ethanol, diethylether, toluene, or DCB can be added to a suspension of graphite or graphene material in DMF/H₂O (at, e.g., 9 to 1 volume ratio). If more than one organic solvent are utilized, such as, for example, a first organic solvent and a second organic solvent, such solvents can be added in any order or simultaneously. In one aspect, a graphite and/or graphene material is first predispersed in water, after which a first organic solvent is added, and after which a second organic solvent is added.

The first and/or second organic solvent can also be selected based on the Taft and Kamlet scales, discussed below, which can be useful for evaluating the presence or absence of a suspension of the graphite or graphene material.

In one aspect, when the compositions comprise graphene oxide, the suspensions can comprise graphene oxide (e.g., about 0.3 mg of graphene oxide per 10 ml in mixed liquid). In this aspect, the ratio of the second to first organic solvent to water can be, for example, about 90:9:1. An exemplary mixture comprises the second organic solvent/DMF/H₂O at a ratio of about 90:9:1. In one specific aspect, the addition of toluene, diethylether, and DCB to a suspension of graphite oxide in DMF/H₂O (9:1) produced black agglomerated powders.

In one aspect, when the compositions comprise suspensions of highly reduced graphene, the mixture can comprise DMF/H₂O at a ratio of about 9:1, which can be mixed with the second solvent, including, for example, one or more of acetone, acetonitrile, THF, DMF, NMP, DMSO, and ethanol. Each of these examples have a δₚ+δₕ from about 13 to about 29 and can show good dispersion of highly reduced graphene. By contrast, highly reduced graphene was not dispersed in suspensions comprising second solvents with a δₚ+δₕ less than about 10 (e.g., DCB, diethylether, and toluene) or much higher than 30 (e.g., water). A first organic solvent and a second organic solvent, if present, can comprise any one or more suitable solvents as described herein, including, but not limited to those solvents recited above. Suitable organic solvents are commercially available, and a suitable solvent or solvents can be selected by one of skill in the art in possession of this disclosure. In one aspect, the composition can further comprise a polymer. In such aspects, the polymer can be suspended or at least partially dissolved in the solvent. Examples of suitable polymers include without limitation substituted polystyrenes, optionally substituted polyethylenes, polypropylenes, polyphenylene vinylene, a light emitting polymer including a fluorescing, phosphorescing, luminescent polymers, or π-conjugated polymers such as, for example, polythiophene, poly(alkyl)thiophene, polyisothianaphthene, polyethylenedioxythiohene, poly-p-phenylenevinylene, poly-(2,5 dialkoxy)-p-phenylenevinylene, poly-p-phenylene, polyheptadiyne, polyaniline, polypyrrole, polyfluorene, poly(2-vinylpyridines). In one aspect, the composition comprises one or more polymers. In another aspect, the composition does not comprise a polymer.

The compositions can also comprise other reagents, for example, if the compositions are being to used to convert a graphite or graphene material into a different graphite or graphene material, as will be discussed below. Examples of such reagents include without limitation reducing agents, e.g, hydrazine, oxidizing agents, acids, bases, coupling agents, or other reagents comprising functional groups that can impart a desired property to the graphite material or graphene material when added thereto. In one aspect, a reagent, if utilized, is capable of chemically and/or physically altering at least a portion of the graphite and/or graphene material. In another aspect, a reagent, if used, can react with at least a portion of the graphite and/or graphene material. In yet another aspect, the composition can comprise one or more reagents of similar or varying composition, and such reagents, if used, can be added simultaneously or sequentially, or with additional steps between each addition. In still another aspect, the composition does not comprise a reagent as described herein.

### C. METHODS

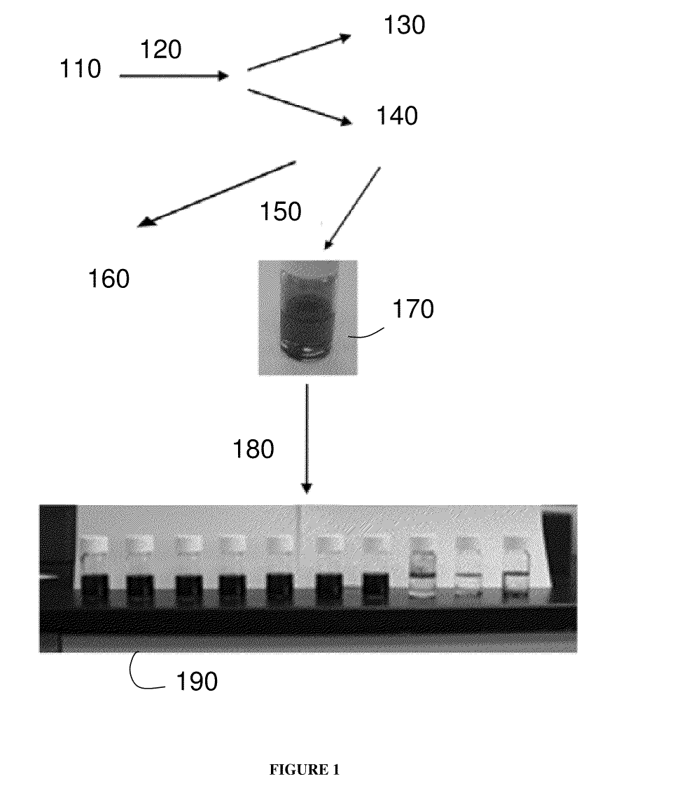

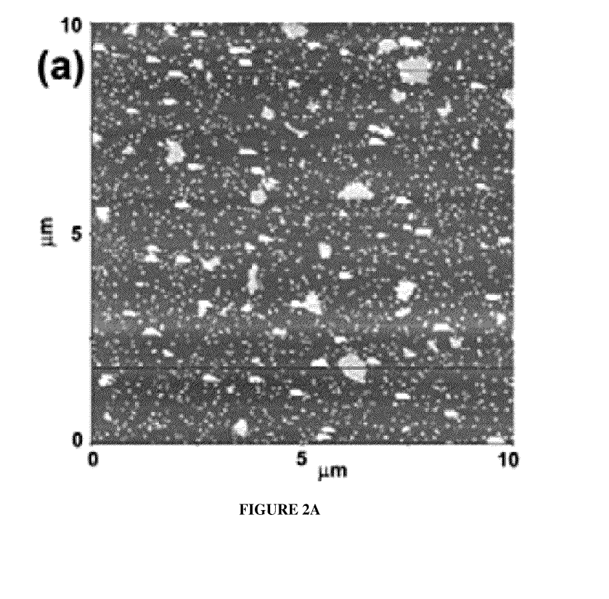

Also disclosed are methods for providing the compositions, methods of using the compositions, and composites and films comprising products and/or isolates of the compositions. In general, the aforementioned compositions can be provided by adding the first organic solvent to a predisperion of the graphite and/or graphene material in water, followed by the addition of the second solvent, if desired. FIG. 1 illustrates an exemplary specific process to provide a disclosed composition. In FIG. 1, a colloidal suspension of graphene oxide in water 110 can be contacted with one or more organic solvents 120 to produce: a large particle 130 (such as for example, with acetone, THF, diethylether, toluene, dicholorbenzene) and/or a colloidal suspension of graphene oxide 140 (such as, for example, with DMF, DMSO, ethanol, NMP, and/or acetonitrile). The colloidal suspension can, in one aspect, then be reduced using hydrazine 150, resulting in agglomeration 160 (such as, for example, with DMSO, ethanol, NMP, and/or acetonitrile) and/or a colloidal suspension of HRG sheets 170 (such as, for example, in DMF/H₂O (9:1)). In another aspect, one or more additional solvents can be added 180 to produce a colloidal suspension of HRG sheets in such solvents 190. The volume ratio used in 190 of FIG. 1 comprise about 90:9:1 of solvent:DMF:H₂O; and the solvents used (from left to right) comprise DMF, ethanol, acetone, THF, DMSO, NMP, acetonitrile, DCB, diethylether, and toluene.

Prior to adding a selected solvent, the solvent can optionally be purified, dried, and/or otherwise treated, if needed. The above mentioned solvents are generally commercially available. Likewise, many graphite and/or graphene materials are commercially available, or can be produced using known methods. In one aspect, all or a portion of the water present in the mixture can optionally be removed by any appropriate technique, such as for example, by distillation, absorption using molecular sieves, and/or the formation of an azeotrope.

When the graphite material comprises graphene oxide, it can, in one aspect, be synthesized from natural graphite (for example, available from SP-1, Bay Carbon, Mich., U.S.A.) by the modified Hummers method, as described in Park, S. et al. “Aqueous suspension and characterization of chemically modified graphene sheets.” Chem. Mater. 2008, 20, 6592-6594. Generally, the method comprises exfoliating graphene oxide into individual graphene oxide sheets followed by in-situ reduction to produce individual graphene-like sheets (e.g., graphene oxide). Other useful methods for producing graphene oxide are discussed in Brodie B C. “Sur le poids atomique du graphite.” Ann Chim Phys 1860; 59:466-72); Hummers W, Offeman R. “Preparation of graphitic oxide.” J Am Chem Soc 1958; 80:1339; and Staudenmaier L. Verfahren zur darstellung der graphitsaure. BerDtsch Chem Ges 1898; 31:1481-99. As an example, an aqueous graphene oxide suspension (e.g., 4 ml H₂O, 3 mg graphene oxide/ml) was generated by sonication (1 hour) of graphene oxide. After addition of DMF (volume ratio DMF/H₂O=9, resulting concentration=0.3 mg graphene oxide/ml), the light-brown suspension of graphene oxide sheets was stable. For example, no floating or precipitated particles were observed after 4 months, or longer.

As discussed above, in one aspect, the compositions can be used to process, e.g., react, the graphite or graphite material to produce a different graphite or graphene material. In one aspect, the method comprises providing a suspension of at least one of a graphite material or graphene material in a mixture having a total volume and comprising a first organic solvent and greater than about 0.1% by volume water, relative to the total volume; and reacting the at least one of a graphite material or graphene material, thereby providing a different graphite material or graphene material.

In a further aspect, the reacting step can comprise adding a reagent to the suspension. Examples of reagents include without limitation reducing agents, e.g, hydrazine, oxidizing agents, acids, bases, coupling agents, or other reagents comprising functional groups that can impart a desired property to the graphite material or graphene material when added thereto.

In one aspect, a reducing agent can be added. Example of reducing agents include without limitation hydrazine monohydrate, hydrogen, formaldehyde, hydroxylamine, or a combination thereof. As a specific example, graphene oxide sheets were reduced in the colloidal suspensions (NMP, ethanol, DMSO, or acetonitrile; each with 9:1 volume ratio to H₂O) by the addition of hydrazine monohydrate. In one aspect, DMF/H₂O can be chosen as the solvent system to provide a colloidal suspension of highly reduced graphene.

In another aspect, a chemically modified graphene material can be produced from a graphite oxide material present in a disclosed suspension. In a specific aspect, a graphite oxide material can be exfoliated, and the resulting graphene oxide sheets reduced, for example, in situ, to produce individual graphene sheets. The reduction of any one or more graphite oxide sheets can be performed using any suitable reduction method, as discussed above. The resulting reduced graphene sheets can be then further functionalized, if desired.

In another aspect, once a starting graphite or graphene material is transformed into a different graphite or graphene material, then the different graphite or graphene material can be isolated from the suspension to provide an isolated graphite material or graphene material. The isolating step can be performed using known methods, such as, for example, filtration, centrifugation, and the like. In another aspect, any graphite and/or graphene material can be isolated from a suspension prepared according to the various aspects described here.

In various aspects, the present invention provides techniques that can maintain a suspension of hydrophobic graphene oxide materials once reduced. In contrast, other known methods describe maintenance of a suspension by shifting the pH of a mixture with hydrazine such that the sheets are negatively charged. In such an approach, the resulting graphene materials would no longer be compatible with H₂O. In one aspect, the methods of the present disclosure do not comprise an intentional pH adjustment to provide a charged sheet.

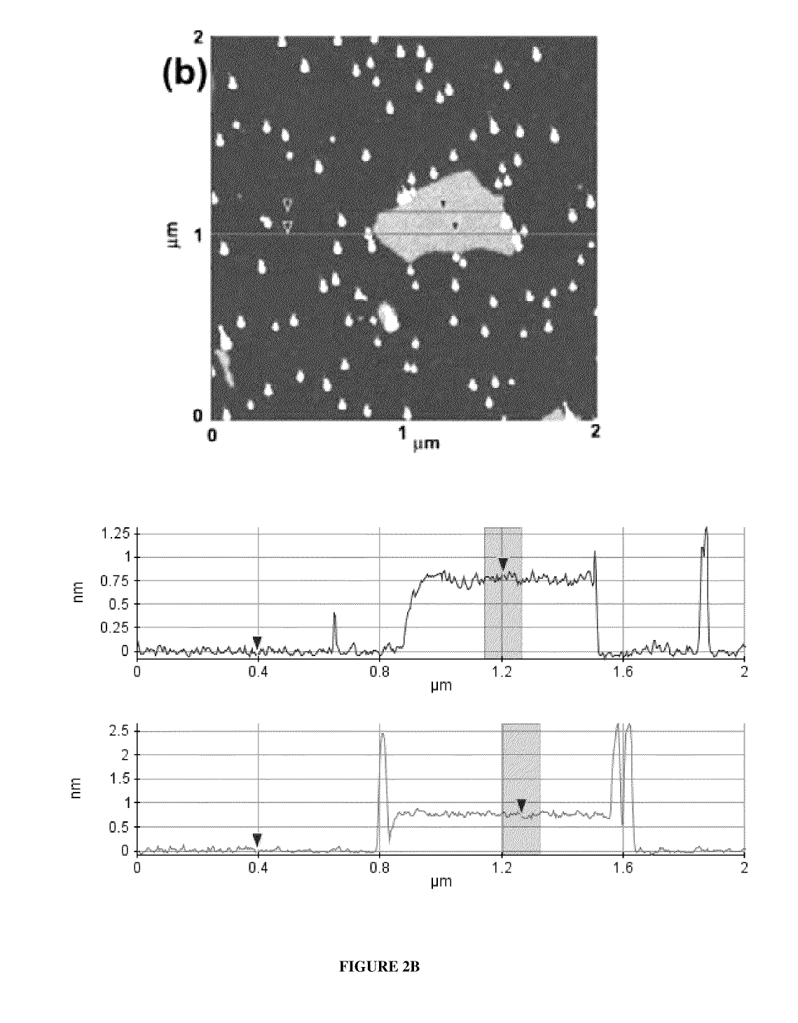

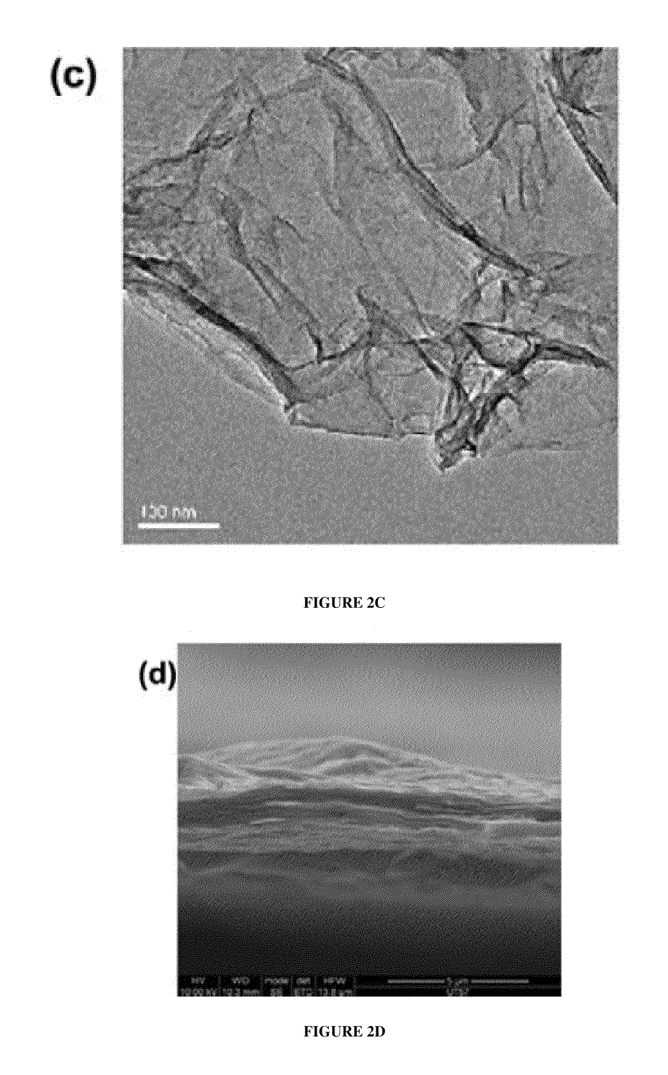

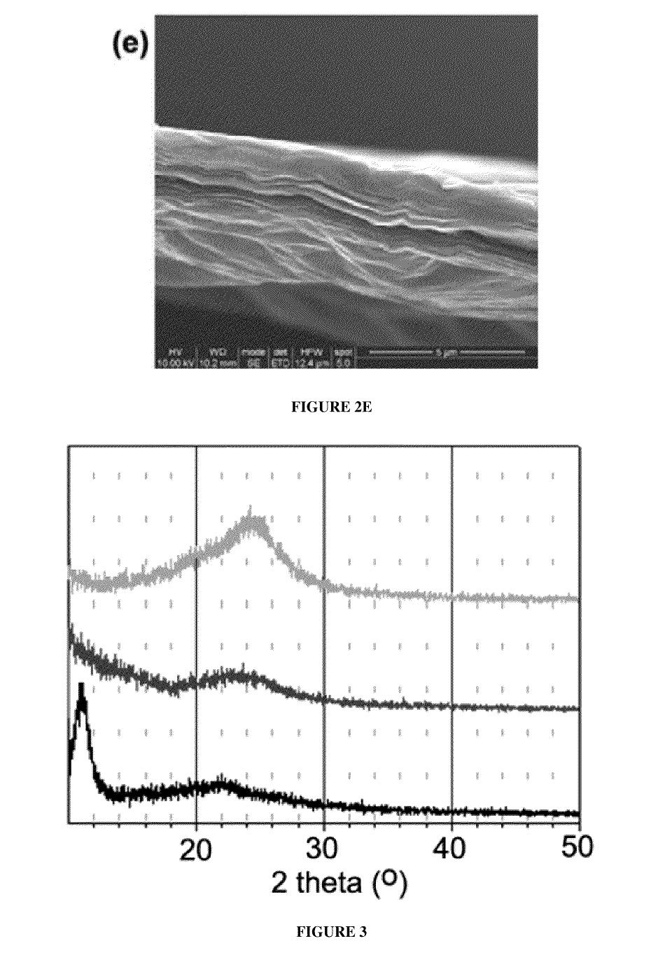

As a specific example, a paper comprising highly reduced graphene oxide sheets (also called highly reduced graphene oxide platelets) was isolated by filtration. Images of the exemplary highly reduced graphene paper are shown in FIGS. 2A-E. In an attempt to remove residual DMF (boiling point=˜152° C.) and/or H₂O trapped in the air-dried highly reduced graphene paper it was dried at ˜150° C. for 12 hours in a tube furnace under a flow of Argon. After this, a layered structure of the highly reduced graphene oxide sheets was maintained, and SEM images of the cross-section of a fractured sample at room temperature (FIG. 2e) were acquired. Based on thermal gravimetric analysis (TGA) under air flow (heating rate=1° C./min), a TGA curve of such an air-dried paper sample showed significant weight loss (10˜20 wt %) before 100° C., likely due to evaporation of water molecules that are contained in the material. A TGA curve of the air-dried paper sample showed no mass loss up to 180° C., indicating that almost no water molecules are trapped in such paper-like samples and thus that the highly reduced graphene oxide material is hydrophobic and is not hygroscopic. The TGA curve of the paper sample comprising highly reduced graphene oxide sheets further showed that the sample lost a small mass (˜4 wt %) from 180 to 260° C. and then lost a significant mass (˜16 wt %) from 260 to 280° C., possibly due to evaporation of trapped DMF and/or loss of CO and CO₂ from decomposition of labile oxygen functional groups; TGA with mass spectrometry readout of evolving gaseous products is indicated for future study. After further drying (at 150° C. under Ar(g)) the air-dried paper, the mass loss was measured (˜27 wt %) with a balance, providing results similar but not identical to the accumulated mass loss measured by TGA from room temperature to 280° C. (˜20 wt %). Elemental analysis by combustion of paper samples showed an increased C/O atomic ratio in the air-dried paper sample (11.0) relative to that in the sample composed of graphene oxide platelets (1.2; this value includes contributions from adsorbed water molecules).

In this example, the C/O atomic ratio (11.0) of air-dried paper comprising highly reduced graphene oxide sheets is slightly higher than those of agglomerated chemically reduced graphene oxide (10.1; reduction with hydrazine monohydrate) or thermally exfoliated graphite oxide (10.3) obtained by expansion of graphene oxide through thermal shock. Nitrogen (˜3.8 wt %) was found in the air-dried paper and can be attributed to N bonded to graphene by hydrazine reduction, and/or perhaps also from residual DMF (C₃H₇NO) and/or hydrazine (N₂H₄)). The C/N atomic ratio (25.7) of the air-dried paper was higher than that found for chemically reduced graphene oxide generated from an aqueous system in which DMF is not used (16.1).

The electrical resistance of exemplary air-dried paper samples was measured by the Van der Pauw method, and an average value for the electrical conductivity of 1.69±0.02×10³ S/m was obtained (from 3 samples).

With reference to FIG. 3, the XRD of the exemplary paper shows a distinct peak at 11.10° corresponding to a d-spacing (in this case, an interlayer distance between sheets) of approximately 7.96 Å that can be due to interlamellar water trapped between hydrophilic graphene oxide sheets. On the other hand, the peak at 11.10° in the XRD spectrum of air-dried paper is not present and a broad peak was observed at around 23° (3.86 Å) close to but larger than the d002-spacing of graphite (3.35 Å). The XRD of the paper dried in this way at 150° C. has a sharper peak with a slight shift in the peak maximum to 24° (approximately 3.70 Å). This shift in the interlayer spacing might be attributed to the reduction of the graphene oxide sheets, where the reduction allows the reduced graphene oxide sheets to pack tighter (smaller interlayer distance between sheets) than the less-reduced counterpart. The electrical conductivity (1.64±0.10×10⁴ S/m; average of 3 samples) dried in this way at 150° C. was ˜9 times higher than that of the samples that were air-dried at room temperature. Based on a comparison with conductivity values reported previously of paper materials composed of chemically modified graphene sheets, the paper samples described herein had higher electrical conductivity (Table 2) with the exception of samples heat-treated at 500° C.

TABLE 2
Electrical conductivities of free-standing paper samples of modified
graphenes.

| | Drying | Conductivity |
|---|---|---|
| Reduced graphene oxide | temperature | (S/m) |
| Highly reduced graphene | Air | 1,700 |
| | At 150° C. | 16,000 |
| Reduced graphene oxide at basic condition | Air | 7,200 |
| | At 220° C. | 11,800 |
| | At 500° C. | 35,100 |
| Reduced K-modified graphene oxide | Air | 690 |
| Pyrene derivative-adsorbed reduced graphene | Air | 200 |
| oxide | | |
| Reduced sulfonated-graphene oxide | At 100° C. | 1,250 |

Thus, in various aspects, a paper can be prepared from a suspended graphite and/or graphene material as described herein, wherein the paper has an electrical conductibity of at least about 1,000 S/m, at least about 1,700 S/m, at least about 5,000 S/m, at least about 10,000 S/m, at least about 11,000 S/m, at least about 12,000 S/m, at least about 13,000 S/m, at least about 14,000 S/m, at least about 15,000 S/m, at least about 15,000 S/m, or at least about 16,000 S/m.

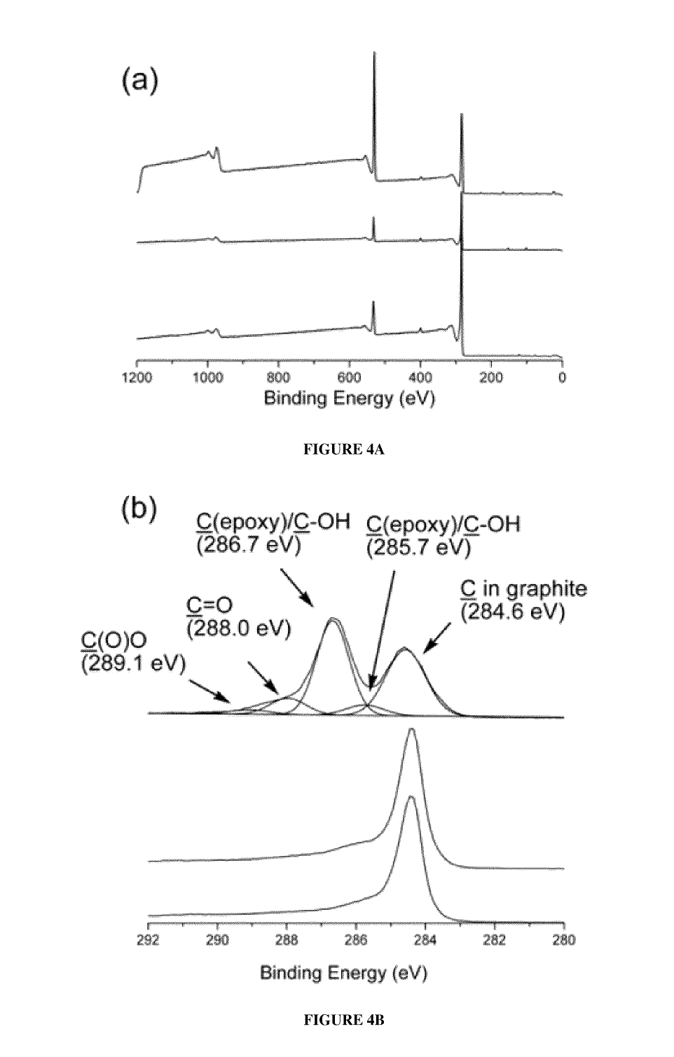

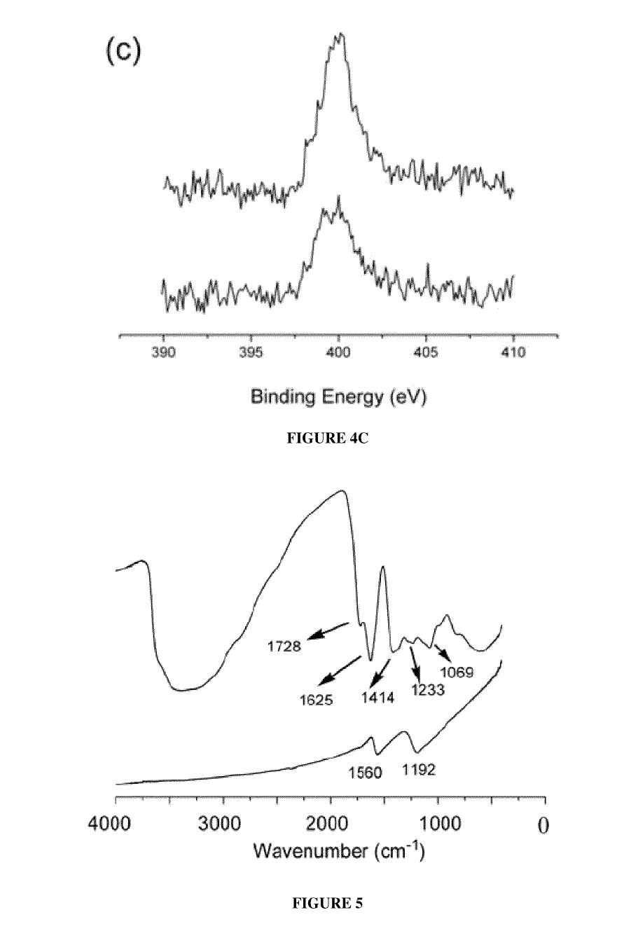

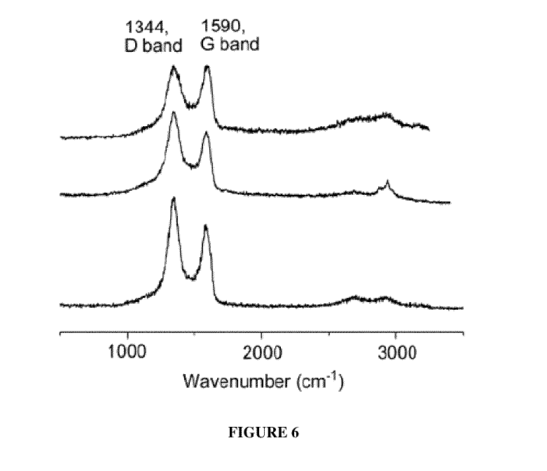

With reference to FIG. 4, reduction of oxygen functional groups in the HRG was also confirmed by X-ray photoelectron spectroscopy (XPS) of paper samples of graphene oxide and separately, of highly reduced graphene. Graphene oxide contains a wide range of oxygen functional groups such as hydroxyl, epoxide, carboxyl, and carbonyl groups. In comparison to the C1s spectrum of the graphene oxide paper, peak(s) assigned to oxygen-containing functional groups in the paper were significantly decreased after reduction. A small peak remains adjacent to the large peak attributed to the C═C bond; this might be due to C—N bonding and/or non-reduced oxygenated carbon. The XPS spectrum of the papers had a small N1s component (that is not observed in the graphene oxide paper) at ˜400 eV corresponding to the C—N bond. A peak is not observed at ˜398 eV (assigned to N—N) likely meaning that if residual hydrazine (NH₂—NH₂) is present, it is below the detection limit of XPS, which probes the surface of such samples. In comparison to the Fourier transformed infrared spectroscopy (FT-IR) spectrum of graphene oxide paper, shown in FIG. 5, peaks due to oxygen functional groups are almost entirely removed in the paper sample. FIG. 6 shows the Raman spectra of the paper samples comprising graphene oxide and highly reduced graphene oxide.

In other aspects, the isolated graphite or graphene material can be processed into a composite comprising a polymer (e.g., a thin film). This can be accomplished using known methods. For example, the polymer can be suspended or at least partially dissolved in the solvent, as discussed above. Then, the mixture comprising the suspension can be drop cast, film cast, or otherwise processed into a composite or film, onto a substrate, or as a free-standing composite. Alternatively, the graphite and/or graphene material can first be isolated from the suspension, and then processed into a composite or film comprising the polymer. Examples of suitable polymers include without limitation substituted polystyrenes, optionally substituted polyethylenes, polypropylenes, polyphenylene vinylene, a light emitting polymer including a fluorescing, phosphorescing, luminescent polymers, or π-conjugated polymers such as, for example, polythiophene, poly(alkyl)thiophene, polyisothianaphthene, polyethylenedioxythiohene, poly-p-phenylenevinylene, poly-(2,5 dialkoxy)-p-phenylenevinylene, poly-p-phenylene, polyheptadiyne, polyaniline, polypyrrole, polyfluorene, poly(2-vinylpyridines), and the like.

The isolated graphite and/or graphene materials, composites and films thereof can be used in a variety of materials, including paints, inks, ultracapacitors, batteries, adsorbents, matrix composite materials, ceramic matrix composites, transparent conductive films, unique film materials that can be transparent or opaque, paper-like materials, and other devices, such as semiconducting devices and photoelectric devices, among others.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Instruments. Bright Field transmission electron microscope (TEM) imaging of highly reduced graphene platelets was done in a JEOL 2010F TEM (200 keV, 151-154 μA, spot size 1). XPS measurements of both graphene oxide and highly reduced graphene paper samples were performed with an Omicron ESCA Probe (Omicron Nanotechnology, Taunusstein, Germany) using monochromatic A1Kα radiation (hv=1486.6 eV). The AFM images were recorded on a Park Systems model XE-100 instrument with scans obtained in non-contact mode with a silicon tip and cantilever operating at a frequency of 300 kHz and a scanning speed of 0.5 Hz. Micro Raman measurements of paper samples were carried out using a WiTec Alpha300 system with a 532-nm wavelength incident laser light. Measurement of the electrical conductivity of highly reduced graphene paper samples was carried out by the Van der Pauw method with a current source (Keithley 6221 DC and AC current source) and two electrometers (both Keithley 6514). Atlantic Microlab, Inc. did the elemental analysis of paper samples. Scanning electron microscope (SEM) images, for the cross-section of paper samples, were measured by an FEI Quanta-600 FEG Environmental SEM. The thermogravimetric analysis (TGA) of paper samples was measured with a PERKIN-ELMER TGA using a 1°/min heating rate in air. Heat-treating highly reduced graphene paper samples at elevated temperature was done in a LINDBERG/BLUE furnace with 100 sccm flow of Ar gas. X-ray Diffraction (XRD) of the air-dried and heat-treated [150° C. under Argon(g)] highly reduced graphene paper samples were recorded for two theta values from 10° to 50° in order to characterize the interlayer spacing. The characterization was done in a Phillips powder X-ray diffractometer at 40 keV 10 and 30 mA with a step size of 0.02° degrees and a dwell time of 2.0 seconds. Samples approximately 3 mm by 3 mm were sectioned and mounted using a low melting temperature wax onto a special Quartz substrate (cut 6° from (0001)) designed to minimize background signal; sample thickness varied from sample to sample, in the range of 2 to 8 μm. The XRD data of a graphene oxide paper material (before reduction) was also obtained. Fourier transformed infrared (FT-IR) spectra were measured on the aforementioned paper samples with a Thermo Mattson Infinity Gold FTIR.

1. Prediction for Dispersion of Graphene Oxide and Highly Reduced Graphene Based on Hansen Solubility Parameters

In a first example, Hansen solubility parameters were used to predict whether a solvent or solvent mixture could disperse graphene oxide or highly reduced graphene.

Hansen solubility parameters are discussed above, and are discussed in more detail in Hansen, C. M. “Hansen Solubility Parameters: A User's Handbook” (CRC Press, Hoboken, 2007).

Approximately 9 ml of a first organic solvent was added to an aqueous suspension (1 ml) of graphene oxide sheets. The dispersibility or lack of dispersibility, depending on the first organic solven selected, can be seen in Table 2. Examplary first organic solvents selected included acetonitrile, dimethyl formamide (DMF), N-methylpyrrolidone (NMP), dimethyl sulfoxide (DMSO), ethanol, pyridine, methanol, and a non-organic solvent, water. The solvents that exhibit values for the sum δₚ+δₕ that are greater than about 20 produced a stable colloidal suspension of hydrophilic graphene oxide, with the exception of propylene carbonate (PC) (δₚ+δₕ=22.1). In contrast to other the solvents mentioned above that disperse graphene oxide sheets, PC has a low value for δₕ (4.1). Without wishing to be bound by theory, this may be a reason for PC not providing a dispersion of graphene oxide.

TABLE 2
Dispersiblity based on Hansen solubility parameters.

| | | Dispersibility | | | | | |
|---|---|---|---|---|---|---|---|
| | | (highly | | | | | |
| | Dispersibility | reduced | | | | | |
| Solvent | (graphene oxide) | graphene) | C₆₀ (mg/ml) | δ_{d} | δₚ | δₕ | δₚ + δₕ |
| Acetone | ◯ | ◯ | 0.001 | 15.5 | 10.4 | 7.0 | 17.4 |
| Acetonitrile | ◯ | ◯ | 0 | 15.3 | 18.0 | 6.1 | 24.1 |
| THF | ◯ | ◯ | 0 | 16.8 | 5.7 | 8.0 | 13.7 |
| DMF | ◯ | ◯ | — | 17.4 | 13.7 | 11.3 | 25.0 |
| NMP | ◯ | ◯ | 0.89 | 18.0 | 12.3 | 7.2 | 19.5 |
| DMSO | ◯ | ◯ | — | 18.4 | 16.4 | 10.2 | 26.6 |
| Ethanol | ◯ | ◯ | 0.001 | 15.8 | 8.8 | 19.4 | 28.2 |
| Pyridine | ◯ | ◯ | 0.89 | 19.0 | 8.8 | 19.4 | 28.2 |
| PC | X | ◯ | — | 20.0 | 18.0 | 4.1 | 22.1 |
| Diethylether | X | X | — | 14.5 | 2.9 | 5.1 | 8.0 |
| Toluene | X | X | 2.8 | 18.0 | 1.4 | 2.0 | 3.4 |
| DCB | immiscible | X | 27 | 19.2 | 6.3 | 3.3 | 9.6 |
| Benzene | immiscible | X | 1.7 | 18.4 | 0 | 2.0 | 2.0 |
| Chloroform | immiscible | X | 0.16 | 17.8 | 3.1 | 5.7 | 8.8 |
| Methanol | ◯ | X | 0 | 15.1 | 12.3 | 22.3 | 34.6 |
| Water | ◯ | X | 0 | 15.5 | 16.0 | 42.3 | 58.3 |

Most agglomerates, if formed, formed after 1 day and could be conveniently re-dispersed by ultrasound. Acetone and THF provide moderately stable suspensions. Abbreviations in Table 2 are as follows, THF: tetrahydrofuran; DMF: N,N-dimethylformamide; NMP: N-methylpyrrolidone, DMSO: dimethylsulfoxide, DCB: 1,2-dichlorobenzene; PC: propylene carbonate. δ_{d}: dispersion cohesion parameter, δₚ: polarity cohesion parameter, δₕ: hydrogen bonding cohesion parameter. ‘Dispersibility’ marked as: O=dispersible; X=not dispersible.

The dispersibility of highly reduced graphene in the solvents listed in Table 2 was compared with the dispersability of single-walled carbon nanotubes (SWCNT) and C₆₀ in terms of Hansen solubility parameters.

It can be seen from Table 2 that solvents having δ_{d}<18 (acetone, acetonitrile, THF, ethanol, methanol, and water) do not well solvate C₆₀ but that solvents with δ_{d}>18 (NMP, pyridine, toluene, DCB, chloroform, and benzene) do dissolve C₆₀ reasonably well. Thus, dispersion (or not) of highly reduced graphene in solvents can be predicted using δₚ+δₕ, while δ_{d} can be more useful for predicting dissolution of C₆₀. A recent study of dispersing SWCNTs showed that consideration of the Hansen solubility parameters δₚ and δₕ was useful for determining dispersability of SWCNTs.

2. Prediction for Dispersion of Graphene Oxide and Highly Reduced Graphene Based on Taft and Kamlet's Scales

In a second example, the dispersibility of highly reduced graphene and graphene oxide sheets in solvents was classified based on the Taft and Kamlet's scales, described in Taft, R. W. & Kamlet, M. J. “The solvatochromic comparison method. 2. The α-scale of solvent hydrogen-bond donor (HBD) acidities. J. Am. Chem. Soc. 1976 98, 2886-2894, using a parameter (E_{T}(30)) (Marcus, Y. “The effectiveness of solvents as hydrogen bond donors.” J. Sol. Chem., 1991 20, 929-944) calculated by Equation 1. The results can be seen in Table 3. The mixed solvents having an E_{T}(30) of from about 39 to about 51 showed a good dispersion of highly reduced graphene, with the exception of chloroform (E_{T}(30)=39.5). By contrast, highly reduced graphene was not dispersed in the exemplary solvents with E_{T}(30) less than about 38 or higher than about 53. Other combinations of the four parameters π*, δ, α, β than those yielding E_{T}(30) can also be used to preduct dispersibility.

The addition of solvents having an E_{T}(30)>43 to the aqueous graphene oxide suspension to achieve a final 9:1 ratio of solvent to H₂O produced a colloidal suspension of hydrophilic graphene oxide sheets, with the exception of PC (E_{T}(30)=46.2).

Equation 1. E_{T}(30)=E_{T}(30)ₒ+s(π*+dδ)+aα+bβ, wherein E_{T}(30)ₒ=30.2 (calculated constant), s=12.99±0.54, sd=−2.74±0.36, a=14.45±0.34, b=2.13±0.51, π*, δ, α, and β, have their usual meaning per the Taft and Kamlet scale.

TABLE 3
Dispersibility based on Taft and Kamlet's parameters.

| | | Dispersibility | | | | | |
|---|---|---|---|---|---|---|---|
| | Dispersibility | (highly | | | | | |
| Solvent | (graphene oxide) | reduced graphene) | π* | δ | α | β | E_{T}(30) |
| Acetone | ◯ | ◯ | 0.71 | 0 | 0.08 | 0.48 | 41.6 |
| Acetonitrile | ◯ | ◯ | 0.75 | 0 | 0.19 | 0.4 | 43.5 |
| THF | ◯ | ◯ | 0.58 | 0 | 0 | 0.55 | 38.9 |
| DMF | ◯ | ◯ | 0.88 | 0 | 0 | 0.69 | 43.1 |
| NMP | ◯ | ◯ | 0.92 | 0 | 0 | 0.77 | 43.8 |
| DMSO | ◯ | ◯ | 1.00 | 0 | 0 | 0.76 | 44.8 |
| Ethanol | ◯ | ◯ | 0.54 | 0 | 0.86 | 0.75 | 51.2 |
| Pyridine | ◯ | ◯ | 0.87 | 1 | 0 | 0.64 | 40.1 |
| PC | X | ◯ | 1.17 | 0 | 0 | 0.4 | 46.2 |
| DCB | immiscible | X | 0.8 | 1 | 0 | 0.03 | 37.9 |
| Diethylether | X | X | 0.27 | 0 | 0 | 0.47 | 34.7 |
| Toluene | X | X | 0.55 | 1 | 0 | 0.11 | 34.8 |
| Benzene | immiscible | X | 0.59 | 1 | 0 | 0.1 | 35.3 |
| Chloroform | immiscible | X | 0.58 | 0.5 | 0.2 | 0.1 | 39.5 |
| Methanol | ◯ | X | 0.6 | 0 | 0.98 | 0.66 | 53.6 |
| Water | ◯ | X | 1.09 | 0 | 1.17 | 0.47 | 62.3 |

Most agglomerates, if formed, formed after 1 day and could be conveniently re-dispersed by ultrasound. Acetone and THF provide moderately stable suspensions. Abbreviations in Table 3 are as follows, THF: tetrahydrofuran; DMF: N,N-dimethylformamide; NMP: N-methylpyrrolidone, DMSO: dimethylsulfoxide, DCB: 1,2-dichlorobenzene; PC: propylene carbonate. δd: dispersion cohesion parameter, δp: polarity cohesion parameter, δh: hydrogen bonding cohesion parameter. ‘Dispersibility’ marked as: O=dispersible; X=not dispersible. π, δ, α, and β: have their usual meaning per the Taft and Kamlet scale.

3. Colloidal Suspensions and Paper Samples of Highly Reduced Graphene.

In a third example, a colloidal suspension of individual graphene oxide sheets in purified water (4 mL, 3 mg/ml) was prepared in 2-L batches with 2 hours of bath ultrasound (VWR B2500A-MT). The graphene oxide suspension in an H₂O/N,Ndimethylformamide (DMF) solvent mixture was obtained by addition of DMF (36 mL) into the aqueous graphene oxide suspensions (thus, volume ratio DMF:H₂O=9), producing a homogeneous suspension of the graphene oxide sheets. Hydrazine monohydrate (1 μl for 3 mg of graphene oxide) (98%, Aldrich) was subsequently added to the suspension (pH=˜6.5). Additional stirring with a Teflon-coated stirring bar at 80° C. for 12 hours yielded a black suspension (pH=˜7) of highly reduced graphene sheets.

After cooling to room temperature, a paper comprising highly reduced graphene oxide was made by filtration of the colloidal suspension through an Anodisc® membrane filter (47 mm in diameter, 0.2-μm pore size, Whatman, Middlesex, UK), after which the deposit was dried in air and peeled off. Some air-dried paper samples were put in a tube furnace under Argon gas flow (pressure: ˜1 atm, rate: 100 sccm); the temperature was increased at 1° C./min, held at 150° C. for 12 hours, then the furnace was cooled naturally to room temperature. Squareshaped paper samples (˜9 mm×9 mm) were prepared, and electrical conductivity was measured for three such samples of the highly reduced graphene paper dried in air at room temperature, and for three such paper. Paper samples comprising graphene oxide were prepared by a similar filtering method and dried in air.

With reference to FIG. 5, the Fourier-transformed infrared spectra of paper comprising graphene oxide showed C═O (1728 cm⁻¹), aromatic C═C (1625 cm⁻¹), carboxy C—O (1414 cm⁻¹), epoxy C—O (1233 cm⁻¹), and alkoxy C—O (1069 cm⁻¹) stretches. After reduction, peaks for oxygen functional groups were significantly reduced and perhaps entirely removed, and two broad peaks at 1560 and 1192 cm⁻¹ were found for the air-dried paper comprising highly reduced graphene oxide. The peak at 1560 cm⁻¹ could be assigned to the aromatic C═C stretch. The peak at 1192 cm⁻¹ can be assigned to the C—O stretch.

4. Attempts at Producing Graphite Oxide or Graphene Oxide Dispersions in DMF without H₂O.

An attempt to disperse graphene oxide in N,N-dimethylformamide (DMF) at different concentrations (0.1-1 mg graphene oxide/ml) by sonication of graphite oxide that had been produced by the modified Hummers method was attempted, as described in Paredes, J. I., Villar-Rodil, S., Martinez-Alonso, A. & Tascon, J. M. D. Graphene oxide dispersions in organic solvents. Langmuir 24, 10560-10564 (2008). However, even lengthy sonication (over 24 hours) in an ultrasound bath did not produce a homogeneous suspension. Further chemical reduction of the mixture using hydrazine monohydrate resulted in agglomerated powders.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising a substantially homogeneous suspension of at least one of a graphite material, a graphene material, or a combination thereof in a liquid comprising a first organic solvent and greater than about 0.1% by volume water.

2. The composition of claim 1, comprising a chemically-functionalized graphene, a reduced graphene, or a combination thereof.

3. The composition of claim 1, comprising greater than about 0.5% by volume water.

4. The composition of claim 1, wherein the at least one of a graphite material or a graphene material is non-intercalated.

5. The composition of claim 1, wherein a stabilizer is not present.

6. The composition of claim 1, wherein the suspension is a homogenous suspension.

7. The composition of claim 1, wherein the suspension is stable for at least about a month.

8. The composition of claim 1, wherein the first organic solvent has a sum of δₚ and δₕ of at least about 10.

9. The composition of claim 1, wherein the first organic solvent comprises acetone, acetonitrile, tetrahydrofuran, dimethyl formamide, N methyl pyrollidone, dimethyl sulfoxide, ethanol, pyridine, diethylether, toluene, methanol, or a combination thereof.

10. The composition of claim 1, wherein the ratio of the first organic solvent to water is about 9:1.

11. The composition of claim 1, further comprising a second organic solvent.

12. A method for preparing a homogeneous suspension of at least one of a graphite material, a graphene material, or a combination thereof, the method comprising:
a. preparing a pre-dispersion of the at least one graphite material, graphene material, or a combination thereof in water; and then
b. adding a first organic solvent to the pre-dispersion to form a homogeneous suspension, such that the volume % of water in the homogeneous suspension is at least about 0.1%.

13. The method of claim 12, wherein the first organic solvent has a sum of δₚ and δₕ of at least about 10.

14. The method of claim 12, wherein the ratio of the first organic solvent to water is about 9:1.

15. The method of claim 12, further comprising filtering the homogeneous suspension to provide a paper type material.

16. The method of claim 15, wherein the paper type material has an electrical conductivity of at least about 10,000 S/m.

17. The method of claim 15, wherein the paper type material has an electrical conductivity of at least about 16,000 S/m.

18. A method for modifying a graphite material or graphene material, the method comprising:
a. providing a suspension of at least one of a graphite material or graphene material in a liquid comprising a first organic solvent and greater than about 0.1% by volume water; and
b. reacting the at least one of a graphite material or graphene material, thereby providing a different graphite material or graphene material.
c.

19. The method of claim 18, further comprising removing at least a portion of the water present in the suspension.

20. The method of claim 18, further comprising isolating the different graphite material or graphene material from the suspension to provide an isolated graphite material or graphene material.
